(19) United States
(12) Patent Application Publication
(10) Pub. No.: US 2024/0168172 A1
(43) Pub. Date: May 23, 2024

(54) Positioning Method, Apparatus, and Device, and Storage Medium

(71) Applicant: Tencent Technology (Schenzhen) Company Limited, Shenzhen (CN)

(72) Inventor: Xingwei GAO, Shenzhen (CH)

(21) Appl. No.: 18/234,811

(22) Filed: Aug. 16, 2023

Related U.S. Application Data
(63) Continuation of application No. PCT/CN2022/132455, filed on Nov. 17, 2022.

(30) Foreign Application Priority Data
Feb. 24, 2023 (CN) 202210175779.5

(51) Int. Cl. G01S 19/41; G01S 19/39

(52) U.S. Cl. CPC G01S 19/41; G01S 19/396

(57) ABSTRACT

Embodiments of this application disclose a method for positioning a terminal performed by a computer device. The method includes: obtaining first actual observation data, second actual observation data, an actual location of a target base station, and actual locations of N satellites; determining an initial estimated location of the terminal based on the first actual observation data and the actual locations of the N satellites; determining, based on the second actual observation data, the actual location of the target base station, and the actual locations of the N satellites, a first system positioning error corresponding to the initial estimated location of the terminal; and adjusting the initial estimated location of the terminal according to the first system positioning error and the first actual observation data, to obtain a target location of the terminal. Location positioning accuracy of the terminal can be improved by using this application.

### CROSS-REFERENCE TO RELATED APPLICATIONS

This application is a continuation application of PCT Patent Application No. PCT/CN2022/132455, entitled “POSITIONING METHOD, APPARATUS, AND DEVICE, AND STORAGE MEDIUM” filed on Nov. 17, 2022, which claims priority to Chinese Patent Application No. 2022101757795, entitled “DATA PROCESSING METHOD, APPARATUS, AND DEVICE, AND STORAGE MEDIUM” filed with the China National Intellectual Property Administration on Feb. 24, 2022, all of which is incorporated herein by reference in its entirety.

### FIELD OF THE TECHNOLOGY

This application relates to the field of intelligent transportation technologies, and in particular, to positioning technologies.

### BACKGROUND OF THE DISCLOSURE

A global navigation satellite system (GNSS) has developed a powerful application of global spatial positioning. A terminal may be positioned by using the global navigation satellite system, and a corresponding service (for example, a path planning service, a taxi hailing service, or recommending a nearby restaurant or hotel for a user) may be provided for a user who uses the terminal based on positioning information of the terminal.

However, limited by a system positioning error (such as an ionospheric error or a tropospheric error) corresponding to the terminal, comprehensive application of satellite navigation and positioning is hindered to some extent. In a process of positioning the terminal by using the global navigation satellite system, a case in which a positioning location of the terminal deviates from an actual location of the terminal easily occurs. Consequently, positioning accuracy of the terminal is relatively low.

### SUMMARY

Embodiments of this application provide a positioning method, apparatus, and device, and a storage medium, to improve positioning accuracy of a terminal.

One aspect of the embodiments of this application provides a method for positioning a terminal, performed by a computer device and the method including:
determining an initial estimated location of the terminal based on the first actual observation data obtained by a terminal by separately performing satellite communication with multiple satellites and actual locations of the satellites;
determining a first system positioning error corresponding to the initial estimated location of the terminal based on an actual location of a target base station associated with the terminal, second actual observation data obtained by the target base station by separately performing satellite communication with the satellites, and the actual locations of the satellites; and
adjusting the initial estimated location of the terminal according to the first system positioning error and the first actual observation data, to obtain a target location of the terminal.

An aspect of the embodiments of this application provides a computer device, including: a processor and a memory,
the processor being connected to the memory; and the memory being configured to store program code that, when executed by the processor, cause the computer device to perform the foregoing method.

An aspect of the embodiments of this application provides a non-transitory computer readable storage medium. The non-transitory computer readable storage medium stores program instructions. When the program instructions are executed by a processor, they cause the computer device to perform the foregoing method.

In this application, the first actual observation data, the second actual observation data, the actual location of the target base station, and the actual locations of the N satellites are obtained, and the initial estimated location of the terminal is determined based on the first actual observation data and the actual locations of the N satellites. The initial estimated location of the terminal is a location for which a system positioning error is not considered. In other words, accuracy of the initial estimated location of the terminal is relatively low. Therefore, the computer device may determine, based on the second actual observation data, the actual locations of the N satellites, and the actual location of the target base station, the first system positioning error corresponding to the initial estimated location of the terminal. The first system positioning error is used for reflecting the accuracy of the initial estimated location of the terminal. Further, the initial estimated location of the terminal may be adjusted according to the first system positioning error and the first actual observation data, to obtain the target location of the terminal. In this way, location positioning accuracy of the terminal can be improved, and high-precision positioning can be implemented.

### BRIEF DESCRIPTION OF THE DRAWINGS

FIG. 1 is a schematic architectural diagram of a positioning system according to this application.

FIG. 2 is a schematic diagram of an interaction scenario between devices in a positioning system according to this application.

FIG. 3 is a schematic flowchart of a positioning method according to this application.

FIG. 4 is a schematic diagram of a scenario of obtaining an initial estimated location of a terminal according to this application.

FIG. 5 is a schematic diagram of a scenario of obtaining an initial estimated location of a terminal according to this application.

FIG. 6 is a schematic flowchart of a positioning method according to this application.

FIG. 7 is a schematic diagram of a scenario in which differential processing is performed on virtual observation data and first actual observation data according to this application.

FIG. 8 is a schematic diagram of a scenario in which an identifier of a vehicle corresponding to a terminal and an identifier of a vehicle corresponding to a neighboring terminal are added to an electronic map according to this application.

FIG. 9 is a schematic structural diagram of a positioning apparatus according to an embodiment of this application.

FIG. 10 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

Before the embodiments of this application are further described in detail, a description is made on nouns and terms in the embodiments of this application, and the nouns and terms in the embodiments of this application are applicable to the following explanations.

Location based service (LBS): The LBS is a location-related service provided by a wireless operator company for users. The LBS obtains a current location of a positioning device by using various types of positioning technologies, and provides an information resource and a basic service for the positioning device by using the mobile Internet. The LBS integrates a plurality of information technologies such as mobile communication, an interconnected network, spatial positioning, location information, and big data, and uses a mobile interconnected network service platform to update and exchange data, so that a user can obtain a corresponding service by means of spatial positioning.

Global navigation satellite system (GNSS): The global navigation satellite system is also referred to as a global satellite navigation system. The global navigation satellite system is an air-based radio navigation positioning system that can provide three-dimensional coordinates, a speed, and time information all the time for a user at a surface of the earth or anywhere in near-earth space. Common global navigation satellite systems include four major navigation satellite systems: the Global Positioning System (GPS), the BeiDou Navigation Satellite System (BDS), the GLONASS Satellite Navigation System (GLONASS), and the European Union Galileo Positioning System (GALILEO). The American GPS appeared first. At present, the most perfect technology is also the GPS system. With the launch of the BDS and GLONASS systems in the Asia-Pacific region in recent years, the BDS system has developed more and more rapidly in the civil field. Satellite navigation systems have been used extensively in communication, consumer entertainment, mapping, time serving, vehicle management, and vehicle navigation and information services, with a general trend towards providing high-precision services for real-time applications.

Base station: The precision of satellite positioning is mainly restricted by various errors related to positioning, such as atmospheric delay errors such as ionospheric and tropospheric, satellite orbit errors and clock differences, multipath effects, relativistic effects, various hardware delays, and observation noise. To eliminate or weaken various errors that restrict a positioning precision of a terminal, a most reliable and effective method is to establish a GNSS base station (or referred to as a reference station) near the terminal. The base station is generally configured with a GPS receiver, a data transmission device, a meteorological device, and the like. Because the base station is fixed and continuously runs for a long time for observation, coordinates of the base station can be accurately measured. In this way, a positioning error at the base station is obtained by processing observation data of the base station.

Electronic map: The electronic map may be a high-precision map that serves an automatic driving system. The high-precision map is also referred to as an automatic driving map and a high-resolution map, and is a new map data paradigm for the automatic driving vehicle. An absolute location precision of the high-precision map is close to 1 m, and a relative location precision is at a centimeter level, and can reach 10-20 cm. A road feature (for example, a lane line feature) is accurately and comprehensively represented, and higher real-time performance is required. This is the most prominent feature of the high-precision map. In addition, the high-precision map may further record specific details of a driving behavior, including a typical driving behavior, an optimal acceleration point and brake point, road condition complexity, labeling of signal receiving of different road sections, and the like.

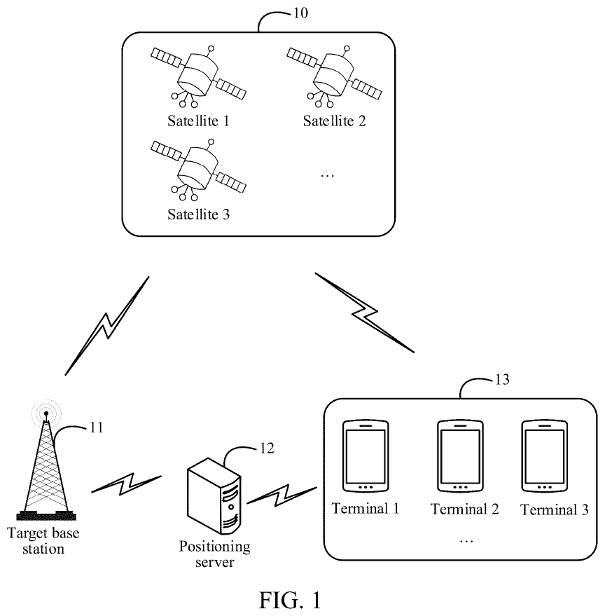

To facilitate clearer understanding of this application, a positioning system applied to a positioning method in this application is first described. As shown in FIG. 1, the positioning system includes a satellite cluster 10, a target base station 11, a positioning server 12, and a terminal cluster 13. The satellite cluster 10 may include one or more satellites, and a quantity of satellites is not limited herein. As shown in FIG. 1, the satellite cluster may specifically include a satellite 1, a satellite 2, a satellite 3, . . . . It may be understood that all satellites in the satellite cluster 10 may be connected to the base station 11 through a network, so that each satellite can exchange data with the base station 11 through the network connection. Likewise, as shown in FIG. 1, the terminal cluster 13 may include one or more terminals, and the terminal cluster 13 may specifically include a terminal 1, a terminal 2, a terminal 3, . . . . It may be understood that all terminals in the terminal cluster 13 may be connected to the satellite in the satellite cluster 10 through a network, so that each terminal can exchange data with each satellite by using the network connection. The positioning server 12 is connected to both the target base station 11 and the terminal in the terminal cluster 13 through a network, so that the positioning server 12 can exchange data with the target base station 11 and each terminal by using the network connection.

The terminal 1 is used as an example. The terminal 1 may be referred to as a mobile terminal, that is, a computer device that can be used during movement. The terminal 1 may be understood as an integrated information processing platform, and has extremely rich communication manners. For example, communication may be performed by using a wireless operation network such as a global system for mobile communication (GSM), code division multiple access (CDMA), wideband code division multiple access (WCDMA), an enhanced data rate for GSM evolution (EDGE), a fourth generation communication technology (4G), and a fifth generation communication technology (5G), or communication may be performed by using a wireless local area network (Wireless Fidelity, Wi-Fi), Bluetooth, and an infrared ray. In addition, a global navigation satellite system positioning chip is integrated into the terminal 1. The global navigation satellite system positioning chip (for example, a high-precision GNSS receiver) may be configured to perform satellite communication with the satellite in the satellite cluster 10, to obtain first actual observation data, and send the first actual observation data to the positioning server 12. The first actual observation data includes at least one of an actual pseudo-range observation value and an actual carrier phase observation value between the terminal 1 and the satellite in the satellite cluster 10. The actual pseudo-range observation value herein is used for reflecting a geometric distance observation value between the terminal 1 and the satellite in the satellite cluster 10. The actual carrier phase observation value is used for reflecting a phase difference between a carrier signal or a subcarrier signal transmitted by the satellite in the satellite cluster 10 and a local oscillator signal of the terminal 1. The local oscillator signal of the terminal 1 is a carrier signal generated by the terminal 1.

A global navigation satellite system positioning chip is integrated into the target base station 11. The global navigation satellite system positioning chip (for example, a high-precision GNSS receiver) may be configured to perform satellite communication with the satellite in the satellite cluster 10, to obtain second actual observation data, and send the second actual observation data to the positioning server 12. The second actual observation data includes at least one of an actual pseudo-range observation value and an actual carrier phase observation value between the target base station 1 and the satellite in the satellite cluster 10. The actual pseudo-range observation value herein is used for reflecting a geometric distance observation value between the target base station 11 and the satellite in the satellite cluster 10. The actual carrier phase observation value is used for reflecting a phase difference between a carrier signal or a subcarrier signal transmitted by the satellite in the satellite cluster 10 and a local oscillator signal of the target base station 11. The local oscillator signal of the target base station 11 is a carrier signal generated by the target base station 11. The target base station 11 herein is associated with the terminal in the terminal cluster 13. The terminal 1 is used as an example. The target base station 11 associated with the terminal 1 is a base station whose distance from the terminal 1 is less than a distance threshold. Alternatively, the target base station 11 is a base station that can perform satellite communication with the satellite in the satellite cluster 10, that is, a satellite cluster used for performing satellite communication with the terminal is the same as a satellite cluster used for performing satellite communication with the target base station.

The positioning server 12 may be configured to perform high-precision positioning on the terminal 1 based on the first actual observation data, the second actual observation data, an actual location of the satellite in the satellite cluster 10, and an actual location of the target base station 11, to obtain a target location of the terminal 1.

The positioning server 12 may be an independent physical server, or may be a server cluster or a distributed system formed by at least two physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal in the terminal cluster 13 may be specifically an in-vehicle terminal, a smartphone, a tablet computer, a notebook computer, a desktop computer, a smart sound box, a screen sound box, a smartwatch, or the like, but is not limited thereto. Each terminal may be directly or indirectly connected to the server in a wired or wireless communication manner. In addition, a quantity of terminals and a quantity of servers may be one or at least two. This is not limited in this application.

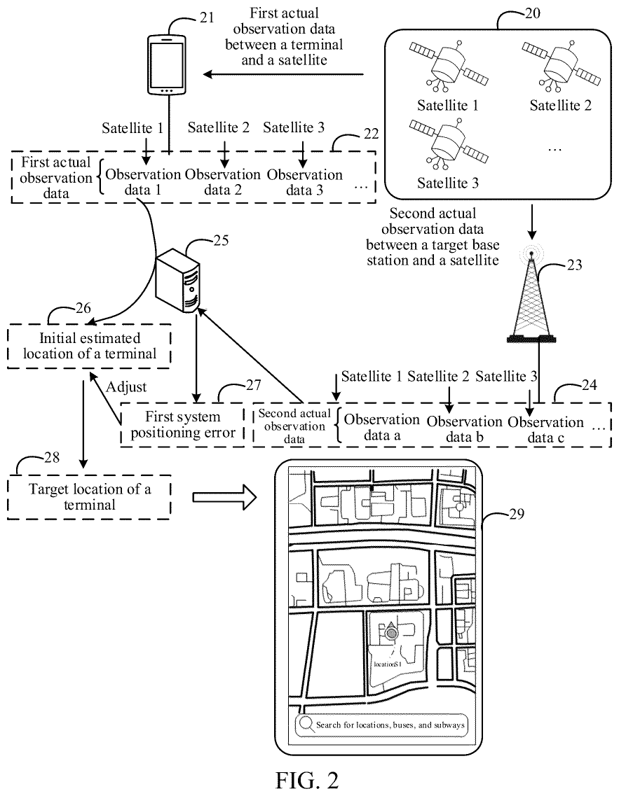

Referring to FIG. 2, FIG. 2 is a schematic diagram of a positioning scenario according to an embodiment of this application. An electronic map application scenario is used as an example to describe a positioning process. As shown in FIG. 2, a satellite cluster 20 may be the satellite cluster 10 in FIG. 1, a terminal 21 may be any terminal in the terminal cluster 13 in FIG. 1, a target base station 23 may be the target base station 11 in FIG. 1, and a positioning server 25 may be the positioning server 12 in FIG. 1.

An electronic map application is installed in the terminal 21. When a user of the terminal 21 wants to query a location, the electronic map application in the terminal 21 may be started. The terminal 21 responds to a start operation for the electronic map application, and displays a home page of the electronic map application on a screen of the terminal 21. Permission prompt information may be displayed on the home page of the electronic map application. The permission prompt information is used for prompting the user that the user is currently obtaining the location of the terminal 21. After obtaining a confirmation operation sent by the user for the permission prompt information, the terminal 21 may obtain first actual observation data obtained by performing satellite communication between the terminal 21 and a satellite in the satellite cluster 20, and send the first actual observation data to the positioning server 25.

The first actual observation data includes at least one of an actual pseudo-range observation value and an actual carrier phase observation value. It is assumed that the satellite cluster 20 includes N satellites, which are respectively a satellite 1, a satellite 2, a satellite 3, . . . , and a satellite N. In this case, first actual observation data obtained by performing satellite communication between the terminal 21 and the satellite 1 may be referred to as observation data 1, first actual observation data obtained by performing satellite communication between the terminal 21 and the satellite 2 may be referred to as observation data 2, first actual observation data obtained by performing satellite communication between the terminal 21 and the satellite 3 may be referred to as observation data 3, . . . , and first actual observation data obtained by performing satellite communication between the terminal 21 and the satellite N may be referred to as observation data N. Therefore, the first actual observation data obtained by performing satellite communication between the terminal 21 and the N satellites is shown in a sequence 22 in FIG. 2.

Likewise, the target base station 23 may obtain second actual observation data obtained by the target base station 23 by performing satellite communication with a satellite in the satellite cluster 20, and send the second actual observation data and an actual location of the target base station 23 to the positioning server 25. The second actual observation data herein includes at least one of an actual pseudo-range observation value and an actual carrier phase observation value. It is assumed that the satellite cluster 20 includes N satellites, which are respectively a satellite 1, a satellite 2, a satellite 3, . . . , and a satellite N. In this case, second actual observation data obtained by performing satellite communication between the target base station 23 and the satellite 1 may be referred to as observation data a, second actual observation data obtained by performing satellite communication between the target base station 23 and the satellite 2 may be referred to as observation data b, second actual observation data obtained by performing satellite communication between the target base station 23 and the satellite 3 may be referred to as observation data c, . . . , and second actual observation data obtained by performing satellite communication between the target base station 23 and the satellite N may be referred to as observation data n. Therefore, the second actual observation data obtained by performing satellite communication between the target base station 23 and the N satellites is shown in a sequence 24 in FIG. 2.

After obtaining the first actual observation data, the second actual observation data, and the actual location of the target base station, the positioning server 25 may determine an initial estimated location 26 of the terminal 21 based on the first actual observation data and actual locations of the N satellites. The initial estimated location 26 is a location obtained without considering a system positioning error, and a relatively large error usually exists between the initial estimated location 26 and an actual location of the terminal 21. Further, the positioning server 25 may obtain an actual location of each satellite in the satellite cluster, and determine a first system positioning error 27 at the initial estimated location 26 of the terminal based on the actual location of each satellite, the actual location of the target base station, and the second actual observation data. The first system positioning error 27 is used for reflecting accuracy of the initial estimated location 26 of the terminal. A larger first system positioning error 27 indicates higher accuracy of the initial estimated location 26 of the terminal. On the contrary, a smaller first system positioning error 27 indicates lower accuracy of the initial estimated location 26 of the terminal.

Further, the positioning server 25 may adjust the initial estimated location 26 of the terminal according to the first system positioning error 27 and the first actual observation data to obtain a target location 28 of the terminal, and send the target location 28 of the terminal to the terminal 21. The terminal 21 may use the target location 28 of the terminal as the actual location of the terminal 21, and mark the target location 28 of the terminal in an electronic map 29 of the electronic map application. As shown in FIG. 2, the target location 28 of the terminal 21 is marked as a location Si. Further, the terminal 21 may perform an operation such as path planning according to the location Si, and adjust the initial estimated location of the terminal according to the first system positioning error and the first actual observation data, so that terminal positioning accuracy can be improved, and high-precision positioning can be implemented.

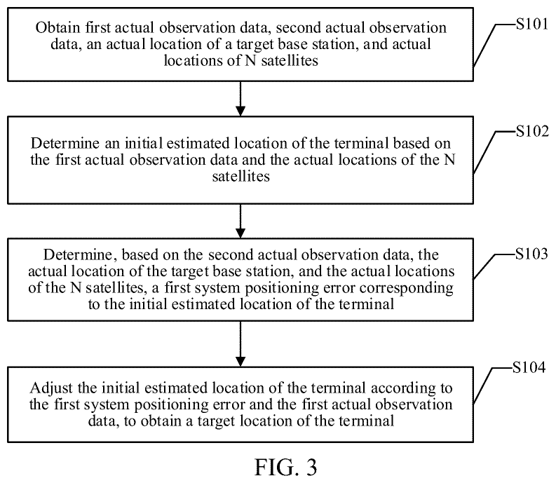

Further, FIG. 3 is a schematic flowchart of a positioning method according to an embodiment of this application. As shown in FIG. 3, the method may be performed by the terminal in FIG. 1, or may be performed by the positioning server in FIG. 1, or may be jointly performed by the terminal and the positioning server in FIG. 1. Devices configured to perform the method in this application may be collectively referred to as a computer device. The positioning method may include the following steps S101 to S104:

S101. Obtain first actual observation data, second actual observation data, an actual location of a target base station, and actual locations of N satellites; the first actual observation data being obtained by a terminal by separately performing satellite communication with the N satellites, and the second actual observation data being obtained by the target base station by separately performing satellite communication with the N satellites; the terminal being associated with the target base station; and N being an integer greater than 1.

In this application, the computer device may obtain the first actual observation data, the second actual observation data, the actual location of the target base station, and the actual locations of the N satellites. The actual location of the target base station is an exact location of the target base station. The actual location of the target base station is determined after the target base station is established. The actual location of the target base station may be manually entered and obtained after the target base station passes a plurality of reviews. The actual location of the satellite is a real-time location of the satellite. The actual location of the satellite may be determined according to a satellite navigation ephemeris sent by the satellite. The satellite navigation ephemeris is an expression used for describing a location and a speed of the satellite. That is, the satellite navigation ephemeris may be an accurate location or a track list of the satellite that changes with time, and the satellite navigation ephemeris may be understood as a function of time.

Satellite communication between the terminal and the satellite may be unidirectional. To be specific, the terminal may receive a first satellite navigation ephemeris sent by the satellite, and determine the first actual observation data between the terminal and the N satellites based on the first satellite navigation ephemeris, or the terminal may receive the first actual observation data sent by the satellite. Likewise, satellite communication between the target base station and the satellite may be unidirectional. To be specific, the target base station may receive a second satellite navigation ephemeris sent by the satellite, and determine the second actual observation data between the target base station and the N satellites based on the second satellite navigation ephemeris, or the target base station may receive the second actual observation data sent by the satellite.

S102. Determine an initial estimated location of the terminal based on the first actual observation data and the actual locations of the N satellites.

In this application, the computer device may determine the initial estimated location of the terminal based on the first actual observation data. The initial estimated location of the terminal may be obtained without considering a system positioning error. Specifically, the computer device may determine the initial estimated location of the terminal in any one or a combination of the following three manners:

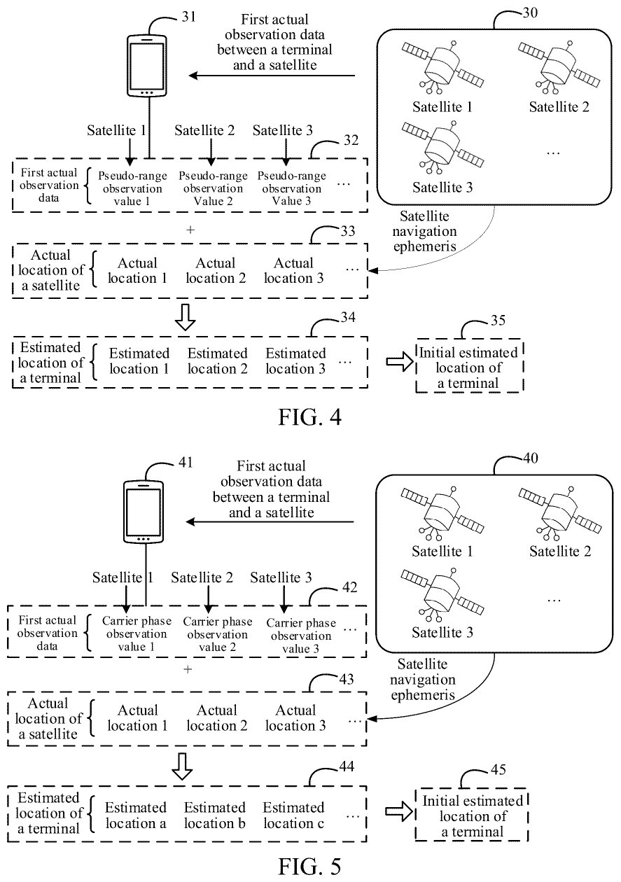

Manner 1: As shown in FIG. 4, a satellite cluster 30 may be the satellite cluster 10 in FIG. 1, and a terminal 31 may be any terminal in the terminal cluster 13 in FIG. 1. The terminal 31 may obtain first actual observation data obtained by performing satellite communication with a satellite in the satellite cluster 30, where the first actual observation data includes an actual pseudo-range observation value. It is assumed that there are N satellites in the satellite cluster 30, which are respectively a satellite 1, a satellite 2, a satellite 3, . . . , and a satellite N. In FIG. 4, an actual pseudo-range observation value between the terminal 31 and the satellite 1 is a pseudo-range observation value 1, an actual pseudo-range observation value between the terminal 31 and the satellite 2 is a pseudo-range observation value 2, an actual pseudo-range observation value between the terminal 31 and the satellite 3 is a pseudo-range observation value 3, . . . , and an actual pseudo-range observation value between the terminal 31 and the satellite N is a pseudo-range observation value N. Therefore, the actual pseudo-range observation values between the terminal 31 and the N satellites are shown in a sequence 32 in FIG. 4. Further, the computer device may separately obtain satellite navigation ephemeris separately sent by the N satellites, and determine actual locations of the N satellites based on the satellite navigation ephemeris. The actual locations of the N satellites are shown in a sequence 33 in FIG. 4. That is, an actual location of the satellite 1 is an actual location 1, an actual location of the satellite 2 is an actual location 2, an actual location of the satellite 3 is an actual location 3, . . . , and an actual location of the satellite N is an actual location N. Then, the computer device may determine the initial estimated location of the terminal based on the pseudo-range observation values and the actual locations of the satellites. Specifically, an estimated location 1 of the terminal is determined according to the pseudo-range observation value 1 and the actual location 1, an estimated location 2 of the terminal is determined according to the pseudo-range observation value 2 and the actual location 2, an estimated location 3 of the terminal is determined according to the pseudo-range observation value 3 and the actual location 3, . . . , and an estimated location N of the terminal is determined according to the pseudo-range observation value N and the actual location N, that is, the estimated locations of the terminal are a sequence 34 shown in FIG. 4. Further, an initial estimated location 35 of the terminal may be determined according to the estimated location 1, the estimated location 2, the estimated location 3, . . . , and the estimated location N. The initial estimated location of the terminal is determined according to the actual pseudo-range observation values between the terminal and the N satellites, so that efficiency of the initial estimated location of the terminal can be improved, and real-time performance of obtaining the initial estimated location of the terminal can be improved.

The determining an estimated location i of the terminal according to a pseudo-range observation value i and an actual location i may be: determining a difference between the pseudo-range observation value i and the actual location i as the estimated location i of the terminal, where i is a positive integer less than or equal to N. The determining the initial estimated location of the terminal according to the estimated location 1, the estimated location 2, the estimated location 3, . . . , and the estimated location N may be: randomly selecting one estimated location from the estimated location 1, the estimated location 2, the estimated locations 3, . . . , and the estimated location N as the initial estimated location of the terminal; or using an average location of the estimated location 1, the estimated location 2, the estimated location 3, . . . , and the estimated location N as the initial estimated location of the terminal. Alternatively, the computer device may obtain a first difference between a first target estimated location and a first remaining estimated location, accumulate first differences to obtain a sum of the first differences, and determine an estimated location corresponding to a smallest sum of the first differences as the initial estimated location of the terminal. The first target estimated location is any estimated location in the estimated location 1, the estimated location 2, the estimated location 3, . . . , and the estimated location N; and the first remaining estimated location is an estimated location other than the first target estimated location in the estimated location 1, the estimated location 2, the estimated location 3, . . . , and the estimated location N.

Manner 2: As shown in FIG. 5, a satellite cluster 40 may be the satellite cluster 10 in FIG. 1, and a terminal 41 may be any terminal in the terminal cluster 13 in FIG. 1. The terminal 41 may obtain first actual observation data obtained by the terminal 41 by performing satellite communication with a satellite in the satellite cluster 40, where the first actual observation data includes an actual carrier phase observation value. It is assumed that there are N satellites in the satellite cluster 40, which are respectively a satellite 1, a satellite 2, a satellite 3, . . . , and a satellite N. In FIG. 5, an actual carrier phase observation value between the terminal 41 and the satellite 1 is a carrier phase observation value 1, an actual carrier phase observation value between the terminal 41 and the satellite 2 is a carrier phase observation value 2, an actual carrier phase observation value between the terminal 41 and the satellite 3 is a carrier phase observation value 3, . . . , and an actual carrier phase observation value between the terminal 41 and the satellite N is a carrier phase observation value N. Therefore, actual carrier phase observation values between the terminal 41 and the N satellites are shown in a sequence 42 in FIG. 5. Further, the computer device may separately obtain satellite navigation ephemeris separately sent by the N satellites, and determine actual locations of the N satellites based on the satellite navigation ephemeris. The actual locations of the N satellites are shown in a sequence 43 in FIG. 5. That is, an actual location of the satellite 1 is an actual location 1, an actual location of the satellite 2 is an actual location 2, an actual location of the satellite 3 is an actual location 3, . . . , and an actual location of the satellite N is an actual location N. Then, the computer device may determine the initial estimated location of the terminal based on the carrier phase observation values and the actual locations of the satellites. Specifically, an estimated location a of the terminal is determined according to the carrier phase observation value 1 and the actual location 1, an estimated location b of the terminal is determined according to the carrier phase observation value 2 and the actual location 2, an estimated location c of the terminal is determined according to the carrier phase observation value 3 and the actual location 3, . . . , and an estimated location n of the terminal is determined according to the carrier phase observation value N and the actual location N. In other words, the estimated locations of the terminal are a sequence 44 shown in FIG. 5. Further, an initial estimated location 45 of the terminal may be determined according to the estimated location a, the estimated location b, the estimated locations c, . . . , and the estimated location n. The initial estimated location of the terminal is determined according to the actual carrier phase observation values between the terminal and the N satellites, so that efficiency of the initial estimated location of the terminal can be improved, and real-time performance of obtaining the initial estimated location of the terminal can be improved.

The determining an estimated location i of the terminal according to a carrier phase observation value i and an actual location i may be: determining a difference between the carrier phase observation value i and the actual location i as the estimated location i of the terminal, where i is a positive integer less than or equal to N. The determining the initial estimated location of the terminal according to the estimated location a, the estimated location b, the estimated locations c, . . . , and the estimated location n may be: randomly selecting one estimated location from the estimated location a, the estimated location b, the estimated locations c, . . . , and the estimated location n as the initial estimated location of the terminal; or using an average location of the estimated location a, the estimated location b, the estimated locations c, . . . , and the estimated location n as the initial estimated location of the terminal. Alternatively, the computer device may obtain a second difference between a second target estimated location and a second remaining estimated location, accumulate second differences to obtain a sum of the second differences, and determine an estimated location corresponding to a smallest sum of the second differences as the initial estimated location of the terminal, where the second target estimated location is any estimated location in the estimated location a, the estimated location b, the estimated locations c, . . . , and the estimated location n, and the second remaining estimated location is an estimated location other than the second target estimated location in the estimated location a, the estimated location b, the estimated locations c, . . . , and the estimated location n.

Manner 3: The first actual observation data includes the foregoing actual carrier phase observation values and actual pseudo-range observation values. It is assumed that the terminal 31 in FIG. 4 and the terminal 41 in FIG. 5 are the same terminal. The computer device may obtain the estimated location 1, the estimated location 2, the estimated location 3, . . . , and the estimated location N of the terminal according to the actual pseudo-range observation values and the actual locations of the satellites, and may obtain the estimated location a, the estimated location b, the estimated location c, . . . , and the estimated location n of the terminal according to the actual carrier phase observation values and the actual locations of the satellites. The computer device may determine the initial estimated location of the terminal according to the estimated location 1, the estimated location 2, the estimated location 3, . . . , the estimated location N, the estimated location a, the estimated location b, the estimated location c, . . . , and the estimated location n of the terminal. For example, one estimated location may be randomly selected from the estimated location 1, the estimated location 2, the estimated location 3, the estimated location . . . , the estimated location N, the estimated location a, the estimated location b, the estimated location c, . . . , and the estimated location n as the initial estimated location of the terminal. Alternatively, an average location of the estimated location 1, the estimated location 2, the estimated location 3, . . . , the estimated location N, the estimated location a, the estimated location b, the estimated locations c, . . . , and the estimated location n as the initial estimated location of the terminal. Alternatively, the computer device may obtain a third difference between a third target estimated location and a third remaining estimated location, accumulate third differences to obtain a sum of the third differences, and determine an estimated location corresponding to a smallest sum of the third differences as the initial estimated location of the terminal, where the third target estimated location is any estimated location in the estimated location 1, the estimated location 2, the estimated location 3, . . . , the estimated location N, the estimated location a, the estimated location b, the estimated location c, . . . , and the estimated location n, and the third remaining estimated location is an estimated location other than the third target estimated location in the estimated location 1, the estimated location 2, the estimated location 3, . . . , the estimated location N, the estimated location a, the estimated location b, the estimated location c, . . . , and the estimated location n. The initial estimated location of the terminal is determined according to the actual pseudo-range observation values and the actual carrier phase observation values between the terminal and the N satellites, so that accuracy of the initial estimated location of the terminal can be improved.

S103. Determine, based on the second actual observation data, the actual location of the target base station, and the actual locations of the N satellites, a first system positioning error corresponding to the initial estimated location of the terminal.

In this application, the computer device may determine, based on the second actual observation data, the actual location of the target base station, and the actual locations of the N satellites, a second system positioning error corresponding to the target base station. Because there is a time correlation and a space correlation between the second system positioning error and the first system positioning error corresponding to the initial estimated location of the terminal, the computer device may determine, based on the second system positioning error, the first system positioning error corresponding to the initial estimated location of the terminal.

In some embodiments, the determining, based on the second actual observation data, the actual location of the target base station, and the actual locations of the N satellites, a first system positioning error corresponding to the initial estimated location of the terminal includes: determining, based on the second actual observation data, the actual location of the target base station, and the actual locations of the N satellites, the second system positioning error corresponding to the target base station, and performing interpolation processing on the second system positioning error based on the initial estimated location of the terminal, the actual location of the target base station, and the actual locations of the N satellites, to obtain the first system positioning error corresponding to the initial estimated location of the terminal.

The computer device may determine, based on the second actual observation data, the actual location of the target base station, and the actual locations of the N satellites, the second system positioning error corresponding to the target base station. The second system positioning error is used for reflecting a system positioning error generated when the location of the terminal is determined at the actual location of the target base station by using the actual observation data. Because the target base station is associated with the terminal, there is a time correlation and a space correlation between the second system positioning error corresponding to the target base station and the system positioning error corresponding to the initial estimated location of the terminal. Therefore, the computer device may perform interpolation processing on the second system positioning error based on the initial estimated location of the terminal, the actual location of the target base station, and the actual locations of the N satellites, to obtain the first system positioning error corresponding to the initial estimated location of the terminal. The interpolation processing may be nearest-neighbor interpolation, quadratic interpolation, cubic interpolation, or the like. The first system positioning error corresponding to the initial estimated location of the terminal is obtained, so as to adjust the initial estimated location of the terminal according to the first system positioning error, obtain a high-precision target location, and improve positioning accuracy of the terminal.

In some embodiments, the second actual observation data includes second actual observation data Qi between the target base station and a satellite Pi, the satellite Pi belongs to the N satellites, and i is a positive integer less than or equal to N. The computer device may obtain, in any one or a combination of the following three manners, the second system positioning error corresponding to the target base station:

Manner 1: The second actual observation data Qi between the target base station and the satellite Pi includes an actual pseudo-range observation value. The computer device may determine an actual distance value between the target base station and the satellite Pi based on the actual location of the target base station and an actual location of the satellite Pi, determine a first difference between the actual pseudo-range observation value and the actual distance value as a first candidate system positioning error between the target base station and the satellite Pi, and determine, based on a first candidate system positioning error between the target base station and each of the N satellites, the second system positioning error corresponding to the actual location of the target base station. The second system positioning error corresponding to the target base station is determined based on the actual pseudo-range observation value in the second actual observation data, so that efficiency of obtaining the second system positioning error can be improved.

For example, when the second actual observation data includes the actual pseudo-range observation value, the computer device may obtain the first candidate system positioning error between the target base station and the satellite Pi by means of calculation according to the following observation equation (1).

ρ=R+C·(dTᵣ−dTₛ)+dₜᵣₒₚ+dᵢₒₙ+d_{orb}+m₁+ε₁ (1)
where ρ is the pseudo-range observation value; R is a geometric distance from the actual location of an observation station to the satellite (that is, an actual distance); dTᵣ and dTₛ respectively indicate a clock difference of the observation station and a satellite clock difference of the satellite; dₜᵣₒₚ dᵢₒₙ, and d_{orb} respectively represent a tropospheric error, an ionospheric refraction error, and a GNSS satellite orbit error; and m₁ and ε₁ indicate a Doppler error and observation noise, respectively.

When the first candidate system positioning error between the target base station and the satellite Pi needs to be calculated, the target base station may be used as an observation station, and the actual distance between the target base station and the satellite and the actual pseudo-range observation value in the second actual observation data are substituted into formula (1) to obtain the first difference between the actual pseudo-range observation value and the actual distance value, that is, ρ−R. The first difference is determined as the first candidate system positioning error between the target base station and the satellite Pi.

Manner 2: The second actual observation data Qi between the target base station and the satellite Pi includes an actual carrier phase observation value. The computer device may determine an actual distance value between the target base station and the satellite Pi based on the actual location of the target base station and an actual location of the satellite Pi, determine a second difference between the actual carrier phase observation value and the actual distance value as the first candidate system positioning error between the target base station and the satellite Pi, and determine, based on a first candidate system positioning error between the target base station and each of the N satellites, the second system positioning error corresponding to the actual location of the target base station. The second system positioning error corresponding to the target base station is determined based on the actual carrier phase observation value in the second actual observation data, so that efficiency of obtaining the second system positioning error can be improved.

For example, when the second actual observation data includes the actual carrier phase observation value, the computer device may obtain the first candidate system positioning error between the target base station and the satellite Pi by means of calculation according to the following observation equation (2).

φ=R+N+C·(dTᵣ−dTₛ)+dₜᵣₒₚ−dᵢₒₙ+d_{orb}+m₂+ε₂ (2)
where φ is the carrier phase observation value; N is carrier phase ambiguity; C is the speed of light; dTᵣ and dTₛ respectively indicate a clock difference of the observation station and a satellite clock difference of the satellite; dₜᵣₒₚ dᵢₒₙ, and d_{orb} respectively represent a tropospheric error, an ionospheric refraction error, and a GNSS satellite orbit error; and m₂ and ε₂ indicate a Doppler error and observation noise, respectively.

When the first candidate system positioning error between the target base station and the satellite Pi needs to be calculated, the target base station may be used as an observation station, and the actual distance between the target base station and the satellite and the actual carrier phase observation value in the second actual observation data are substituted into formula (2) to obtain the second difference between the actual carrier phase observation value and the actual distance value, that is, φ−R. The second difference is determined as the first candidate system positioning error between the target base station and the satellite Pi.

Manner 3: The second actual observation data Qi between the target base station and the satellite Pi includes an actual pseudo-range observation value and an actual carrier phase observation value. The computer device may determine an actual distance value between the target base station and the satellite Pi based on the actual location of the target base station and an actual location of the satellite Pi, obtain a first difference between the actual pseudo-range observation value and the actual distance value, and a second difference between the actual carrier phase observation value and the actual distance value, determine a first candidate system positioning error between the target base station and the satellite Pi based on the first difference and the second difference, and determine, based on a first candidate system positioning error between the target base station and each of the N satellites, the second system positioning error corresponding to the actual location of the target base station. The second system positioning error corresponding to the target base station is determined based on the actual pseudo-range observation value and the actual carrier phase observation value in the second actual observation data, so that accuracy of obtaining the second system positioning error can be improved.

For example, when the second actual observation data includes the actual pseudo-range observation value and the actual carrier phase observation value, the computer device may determine the first candidate system positioning error between the target base station and the satellite Pi based on ρ−R and φ−R.

In some embodiments, the performing interpolation processing on the second system positioning error based on the initial estimated location of the terminal, the actual location of the target base station, and the actual locations of the N satellites, to obtain the first system positioning error corresponding to the initial estimated location of the terminal includes: obtaining a correlation function between the actual location of the target base station, the actual locations of the N satellites, and the second system positioning error, and determining a second candidate system positioning error between the terminal and the satellite Pi based on the correlation function, the initial estimated location of the terminal, and the actual location of the satellite Pi; and determining, based on a second candidate system positioning error between the terminal and each of the N satellites, the first system positioning error corresponding to the initial estimated location of the terminal.

The computer device may fit the actual location of the target base station, the actual locations of the N satellites, and the second system positioning error, to obtain a correlation function between the actual location of the target base station, the actual locations of the N satellites, and the second system positioning error, where the correlation function is used for reflecting a correlation relationship between the actual location of the target base station, the actual locations of the N satellites, and the second system positioning error. Because there is a time correlation and a space correlation between the second system positioning error corresponding to the target base station and the system positioning error corresponding to the initial estimated location of the terminal, that is, a correlation relationship between the initial estimated location of the terminal, the actual locations of the N satellites, and the system positioning error corresponding to the initial estimated location of the terminal is the same as or similar to the correlation relationship between the actual location of the target base station, the actual locations of the N satellites, and the second system positioning error. Therefore, a second candidate system positioning error between the terminal and the satellite Pi may be determined based on the correlation function, the initial estimated location of the terminal, and the actual location of the satellite Pi. To be specific, the actual location of the satellite Pi and the initial estimated location of the terminal are substituted into the correlation function, the second candidate system positioning error between the terminal and the satellite Pi is obtained by means of solving, and the second candidate system positioning error between the terminal and each of the N satellites is determined as the first system positioning error corresponding to the initial estimated location of the terminal.

For example, when the second system positioning error includes the first difference between the actual pseudo-range observation value and the actual distance value, the computer device may fit the actual location of the target base station, the actual locations of the N satellites, and the first difference corresponding to each satellite, to obtain a first correlation function between the actual location of the target base station, the actual locations of the N satellites, and the first difference. The first correlation function is used for reflecting the correlation relationship between the actual location of the target base station, the actual locations of the N satellites, and the first difference. A first initial system positioning error between the terminal and the satellite Pi may be determined based on the first correlation function, the initial estimated location of the terminal, and the actual location of the satellite Pi, and the first initial system positioning error is determined as the second candidate system positioning error. To be specific, the actual location of the satellite Pi and the initial estimated location of the terminal are substituted into the first correlation function, and the second candidate system positioning error between the terminal and the satellite Pi is obtained by means of solving. The second candidate system positioning error between the terminal and each of the N satellites is determined as the first system positioning error corresponding to the initial estimated location of the terminal. In other words, the first system positioning error herein includes the first initial system positioning error between the terminal and each satellite.

For example, when the second system positioning error includes the second difference between the actual carrier phase observation value and the actual distance value, the computer device may fit the actual location of the target base station, the actual locations of the N satellites, and the second difference corresponding to each satellite, to obtain a second correlation function between the actual location of the target base station, the actual locations of the N satellites, and the second difference. The second correlation function is used for reflecting the correlation relationship between the actual location of the target base station, the actual locations of the N satellites, and the second difference. A second initial system positioning error between the terminal and the satellite Pi may be determined based on the second correlation function, the initial estimated location of the terminal, and the actual location of the satellite Pi, and the second initial system positioning error is determined as the second candidate system positioning error. To be specific, the actual location of the satellite Pi and the initial estimated location of the terminal are substituted into the second correlation function, and the second candidate system positioning error between the terminal and the satellite Pi is obtained by means of solving. The second candidate system positioning error between the terminal and each of the N satellites is determined as the first system positioning error corresponding to the initial estimated location of the terminal. In other words, the first system positioning error herein includes the second initial system positioning error between the terminal and each satellite.

For example, when the second system positioning error includes the first difference between the actual pseudo-range observation value and the actual distance value, and the second difference between the actual carrier phase observation value and the actual distance value, the computer device may determine the first initial system positioning error and the second initial system positioning error as the second candidate system positioning error between the terminal and the satellite Pi, and determine the second candidate system positioning error between the terminal and each of the N satellites as the first system positioning error at the initial estimated location of the terminal. In other words, the first system positioning error herein includes the first initial system positioning error and the second initial system positioning error between the terminal and each satellite.

S104. Adjust the initial estimated location of the terminal according to the first system positioning error and the first actual observation data, to obtain a target location of the terminal.

In this application, accuracy of the initial estimated location of the terminal is relatively low. Therefore, the computer device may adjust the initial estimated location of the terminal based on the first system positioning error and the first actual observation data, to obtain the target location of the terminal. Therefore, accuracy of location positioning of the terminal can be improved, and high-precision positioning can be implemented.

In this application, the first actual observation data, the second actual observation data, the actual location of the target base station, and the actual locations of the N satellites are obtained, and the initial estimated location of the terminal is determined based on the first actual observation data and the actual locations of the N satellites. The initial estimated location of the terminal is a location for which a system positioning error is not considered. In other words, accuracy of the initial estimated location of the terminal is relatively low. Therefore, the computer device may determine, based on the second actual observation data, the actual locations of the N satellites, and the actual location of the target base station, the first system positioning error corresponding to the initial estimated location of the terminal. The first system positioning error is used for reflecting the accuracy of the initial estimated location of the terminal. Further, the initial estimated location of the terminal may be adjusted according to the first system positioning error and the first actual observation data, to obtain the target location of the terminal. In this way, location positioning accuracy of the terminal can be improved, and high-precision positioning can be implemented.

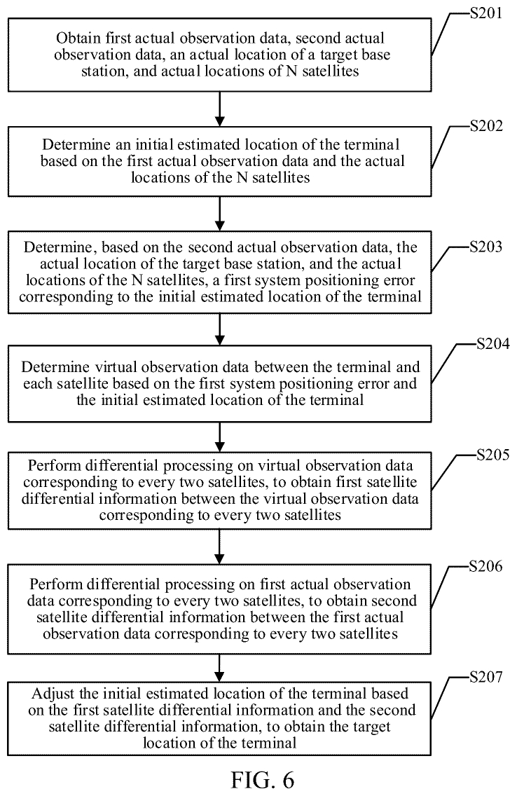

Further, FIG. 6 is a schematic flowchart of a positioning method according to an embodiment of this application. As shown in FIG. 6, the method may be performed by the terminal in FIG. 1, or may be performed by the server in FIG. 1, or may be jointly performed by the terminal and the server in FIG. 1. Devices configured to perform the method in this application may be collectively referred to as a computer device. The positioning method may include the following steps S201 to S207:

S201. Obtain first actual observation data, second actual observation data, an actual location of a target base station, and actual locations of N satellites; the first actual observation data being obtained by a terminal by separately performing satellite communication with the N satellites, and the second actual observation data being obtained by the target base station by separately performing satellite communication with the N satellites. The terminal is associated with the target base station, and N is an integer greater than 1.

S202. Determine an initial estimated location of the terminal based on the first actual observation data and the actual locations of the N satellites.

S203. Determine, based on the second actual observation data, the actual location of the target base station, and the actual locations of the N satellites, a first system positioning error corresponding to the initial estimated location of the terminal.

S204. Determine virtual observation data between the terminal and each satellite based on the first system positioning error and the initial estimated location of the terminal.

In this application, the computer device may determine the virtual observation data between the terminal and each satellite based on the first system positioning error and the initial estimated location of the terminal. The virtual observation data herein is not obtained by performing satellite communication between the terminal and the satellite, but is obtained through calculation based on the first system positioning error and the initial estimated location of the terminal.

For example, when the first system positioning error includes a first initial system positioning error between the terminal and a satellite Pi, the computer device may use the terminal as an observation station, and use a distance between the initial estimated location of the terminal and an actual location of the satellite Pi as an actual distance between the terminal and the satellite Pi. Further, the actual distance between the terminal and the satellite Pi and the first system positioning error are substituted into the foregoing formula (1) to obtain the virtual pseudo-range observation value, that is, a sum of the actual distance between the terminal and the satellite Pi and the first initial system positioning error is determined as the virtual pseudo-range observation value, and the virtual pseudo-range observation value is determined as virtual observation data between the terminal and the satellite Pi.

For another example, when the first system positioning error includes a second initial system positioning error between the terminal and a satellite Pi, the computer device may use the terminal as an observation station, and use a distance between the initial estimated location of the terminal and an actual location of the satellite Pi as an actual distance between the terminal and the satellite Pi. Further, the actual distance between the terminal and the satellite Pi and the second system positioning error are substituted into the foregoing formula (2) to obtain the virtual carrier phase observation value, that is, a sum of the actual distance between the terminal and the satellite Pi and the second initial system positioning error is determined as the virtual carrier phase observation value, and the virtual carrier phase observation value is determined as the virtual observation data between the terminal and the satellite Pi.

For another example, when the first system positioning error includes the first initial system positioning error and the second initial system positioning error between the terminal and the satellite Pi, the virtual pseudo-range observation value between the terminal and the satellite Pi is determined based on the first initial system positioning error, the virtual carrier phase observation value between the terminal and the satellite Pi is determined based on the second initial system positioning error, and the virtual pseudo-range observation value and the virtual carrier phase observation value are determined as the virtual observation data between the terminal and the satellite Pi.

S205. Perform differential processing on virtual observation data corresponding to every two satellites, to obtain first satellite differential information between the virtual observation data corresponding to every two satellites.

In some embodiments, when virtual observation data between the terminal and a satellite Pi includes a first virtual pseudo-range observation value, the virtual observation data between the terminal and the satellite Pj includes a second virtual pseudo-range observation value. Both the satellite Pi and the satellite Pj belong to the N satellites, and both i and j are positive integers less than or equal to N; and j is not the same as i. The computer device may use the terminal as an observation station, substitute the first virtual pseudo-range observation value into the foregoing formula (1) to obtain a first virtual pseudo-range observation equation corresponding to the first virtual pseudo-range observation value, and substitute the second virtual pseudo-range observation value into the foregoing formula (1) to obtain a second virtual pseudo-range observation equation corresponding to the second virtual pseudo-range observation value. Further, first satellite differential information between the virtual observation data respectively corresponding to the satellite Pi and the satellite Pj is determined according to the first virtual pseudo-range observation equation and the second virtual pseudo-range observation equation, that is, the first satellite differential information herein includes a virtual single-difference pseudo-range observation equation. Differential processing is performed on the virtual pseudo-range observation value, which helps weaken the system positioning error corresponding to the initial estimated location of the terminal, and improves location positioning precision of the terminal.

For example, difference calculation processing is performed on the first virtual pseudo-range observation equation and the second virtual pseudo-range observation equation to obtain a virtual single-difference pseudo-range observation equation, and the virtual single-difference pseudo-range observation equation is determined as the first satellite differential information between the virtual observation data respectively corresponding to the satellite Pi and the satellite Pj. For example, the virtual single-difference pseudo-range observation equation may be expressed by using the following formula (3):

Δρ=ΔR+C·ΔdTₛ+Δdₜᵣₒₚ+Δdᵢₒₙ+Δd_{orb}+Δm₁+Δε₁ (3)
where Δ(*)=(*)ᵢ−(*)ⱼ indicates single-difference operation, for example, Δp is a difference between the virtual pseudo-range observation value corresponding to the satellite Pi and the virtual pseudo-range observation value corresponding to the satellite Pi, and ΔR is a difference between an actual distance between the actual location of the terminal and the location of the satellite Pi, and an actual distance between the actual location of the terminal and the location of the satellite Pj. It can be learned by comparing formula (3) with formula (1) that a term including the clock difference of the terminal is eliminated, and other related errors such as an ionospheric error and a tropospheric refraction error are also weakened.

In some embodiments, when the virtual observation data between the terminal and the satellite Pi includes a first virtual carrier phase observation value, the virtual observation data between the terminal and the satellite Pj includes a second virtual carrier phase observation value. Both the satellite Pi and the satellite Pj belong to the N satellites, and both i and j are positive integers less than or equal to N; and j is not the same as i. The computer device may use the terminal as an observation station, substitute the first virtual carrier phase observation value into the foregoing formula (2) to obtain a first virtual carrier phase observation equation corresponding to the first virtual carrier phase observation value, and substitute the second virtual carrier phase observation value into the foregoing formula (2) to obtain a second virtual carrier phase observation equation corresponding to the second virtual carrier phase observation value. Further, the first satellite differential information between the virtual observation data respectively corresponding to the satellite Pi and the satellite Pj is determined according to the first virtual carrier phase observation equation and the second virtual carrier phase observation equation. Differential processing is performed on the virtual carrier phase observation value, which helps weaken the system positioning error corresponding to the initial estimated location of the terminal, and improves location positioning accuracy of the terminal.

For example, difference calculation processing is performed on the first virtual carrier phase observation equation and the second virtual carrier phase observation equation to obtain a virtual single-difference carrier phase observation equation, and the virtual single-difference carrier phase equation is determined as the first satellite differential information between the virtual observation data respectively corresponding to the satellite Pi and the satellite Pj, that is, the first satellite differential information herein includes the virtual single-difference carrier phase observation equation. For example, the virtual single-difference carrier phase observation equation may be expressed by using the following formula (4):

Δφ=ΔR+ΔN+C·ΔdTₛ+Δdₜᵣₒₚ−Δdᵢₒₙ+Δd_{orb}+Δm₂+Δε₂ (4)
where Δ(*)=(*)ᵢ−(*)ⱼ indicates single-difference operation, for example, Δφ is a difference between the virtual carrier phase observation value corresponding to the satellite Pi and the virtual carrier phase observation value corresponding to the satellite Pj. It can be learned by comparing formula (4) with formula (2) that a term including the clock difference of the terminal is eliminated, and other related errors such as an ionospheric error and a tropospheric refraction error are also weakened.

In some embodiments, virtual observation data between the terminal and a satellite Pi includes a first virtual pseudo-range observation value and a first virtual carrier phase observation value, and virtual observation data between the terminal and a satellite Pj includes a second virtual pseudo-range observation value and a second virtual carrier phase observation value. Both the satellite Pi and the satellite Pj belong to the N satellites, and both i and j are positive integers less than or equal to N; and j is not the same as i. The computer device may use the terminal as an observation station, substitute the first virtual pseudo-range observation value into the foregoing formula (1) to obtain a first virtual pseudo-range observation equation corresponding to the first virtual pseudo-range observation value, and substitute the second virtual pseudo-range observation value into the foregoing formula (1) to obtain a second virtual pseudo-range observation equation corresponding to the second virtual pseudo-range observation value; and substitute the first virtual carrier phase observation value into the foregoing formula (2) to obtain a first virtual carrier phase observation equation corresponding to the first virtual carrier phase observation value, and substitute the second virtual carrier phase observation value into the foregoing formula (2) to obtain a second virtual carrier phase observation equation corresponding to the second virtual carrier phase observation value. Further, first satellite differential information between virtual observation data respectively corresponding to the satellite Pi and the satellite Pj is determined according to the first virtual pseudo-range observation equation, the second virtual pseudo-range observation equation, the first virtual carrier phase observation equation, and the second virtual carrier phase observation equation.

For example, the computer device may perform difference calculation processing on the first virtual pseudo-range observation equation and the second virtual pseudo-range observation equation to obtain a virtual single-difference pseudo-range observation equation; perform difference calculation processing on the first virtual carrier phase observation equation and the second virtual carrier phase observation equation to obtain a virtual single-difference carrier phase observation equation; and determine first satellite differential information between the virtual observation data respectively corresponding to the satellite Pi and the satellite Pj according to the virtual single-difference pseudo-range observation equation and the virtual single-difference carrier phase observation equation, that is, use the foregoing formula (3) and formula (4) as the first satellite differential information, that is, the first satellite differential information herein includes the virtual single-difference pseudo-range observation equation and the virtual single-difference carrier phase observation equation. Differential processing is performed on the virtual pseudo-range observation value and the virtual carrier phase observation value, which helps weaken the system positioning error at the initial estimated location of the terminal, and improves location positioning accuracy of the terminal.

S206. Perform differential processing on first actual observation data corresponding to every two satellites, to obtain second satellite differential information between the first actual observation data corresponding to every two satellites.

In this application, the computer device performs differential processing on the first actual observation data corresponding to every two satellites, to obtain the second satellite differential information between the first actual observation data corresponding to every two satellites. This helps weaken the system positioning error at the initial estimated location of the terminal, and further improves location positioning accuracy of the terminal.

In some embodiments, the computer device may obtain, in any one or a combination of the following three manners, the second satellite differential information between the first actual observation data corresponding to every two satellites:

Manner 1: When the first actual observation data between the terminal and the satellite Pi includes the first actual pseudo-range observation value, the first actual observation data between the terminal and the satellite Pj includes the second actual pseudo-range observation value. The computer device may use the terminal as an observation station, substitute the first actual pseudo-range observation value into the foregoing formula (1) to obtain a first actual pseudo-range observation equation corresponding to the first actual pseudo-range observation value, and substitute the second actual pseudo-range observation value into the foregoing formula (1) to obtain a second actual pseudo-range observation equation corresponding to the second actual pseudo-range observation value. Further, second satellite differential information between the actual observation data respectively corresponding to the satellite Pi and the satellite Pj is determined according to the first actual pseudo-range observation equation and the second actual pseudo-range observation equation. Differential processing is performed on the actual pseudo-range observation value, which helps weaken the system positioning error at the initial estimated location of the terminal, and improves location positioning accuracy of the terminal.

For example, difference calculation processing is performed on the first actual pseudo-range observation equation and the second actual pseudo-range observation equation to obtain an actual single-difference pseudo-range observation equation, and the actual single-difference pseudo-range observation equation is determined as the second satellite differential information between the first actual observation data respectively corresponding to the satellite Pi and the satellite Pj, that is, the second satellite differential information herein includes the actual single-difference pseudo-range observation equation.

Manner 2: When the first actual observation data between the terminal and the satellite Pi includes the first actual carrier phase observation value, the first actual observation data between the terminal and the satellite Pj includes the second actual carrier phase observation value. The computer device may use the terminal as an observation station, substitute the first actual carrier phase observation value into the foregoing formula (2) to obtain a first actual carrier phase observation equation corresponding to the first actual carrier phase observation value, and substitute the second actual carrier phase observation value into the foregoing formula (2) to obtain a second actual carrier phase observation equation corresponding to the second actual carrier phase observation value. Further, the second satellite differential information between the actual observation data respectively corresponding to the satellite Pi and the satellite Pj is determined according to the first actual carrier phase observation equation and the second actual carrier phase observation equation. Differential processing is performed on the actual carrier phase observation value, which helps weaken the system positioning error at the initial estimated location of the terminal, and improves location positioning accuracy of the terminal.

For example, difference calculation processing is performed on the first actual carrier phase observation equation and the second actual carrier phase observation equation to obtain an actual single-difference carrier phase observation equation, and the actual single-difference carrier phase equation is determined as the second satellite differential information between the first actual observation data respectively corresponding to the satellite Pi and the satellite Pj, that is, the second satellite differential information herein includes the actual single-difference carrier phase observation equation.

Manner 3: First actual observation data between the terminal and a satellite Pi includes a first actual pseudo-range observation value and a first actual carrier phase observation value, and first actual observation data between the terminal and a satellite Pj includes a second actual pseudo-range observation value and a second actual carrier phase observation value. The computer device may use the terminal as an observation station, substitute the first actual pseudo-range observation value into the foregoing formula (1) to obtain a first actual pseudo-range observation equation corresponding to the first actual pseudo-range observation value, and substitute the second actual pseudo-range observation value into the foregoing formula (1) to obtain a second actual pseudo-range observation equation corresponding to the second actual pseudo-range observation value; and substitute the first actual carrier phase observation value into the foregoing formula (2) to obtain a first actual carrier phase observation equation corresponding to the first actual carrier phase observation value, and substitute the second actual carrier phase observation value into the foregoing formula (2) to obtain a second actual carrier phase observation equation corresponding to the second actual carrier phase observation value. Second satellite differential information between first actual observation data respectively corresponding to the satellite Pi and the satellite Pj is determined according to the first actual pseudo-range observation equation, the second actual pseudo-range observation equation, the first actual carrier phase observation equation, and the second actual carrier phase observation equation.

For example, the computer device may perform difference calculation processing on the first actual pseudo-range observation equation and the second actual pseudo-range observation equation to obtain an actual single-difference pseudo-range observation equation; perform difference calculation processing on the first actual carrier phase observation equation and the second actual carrier phase observation equation to obtain an actual single-difference carrier phase observation equation; and determine the actual single-difference pseudo-range observation equation and the actual single-difference carrier phase observation equation as the second satellite differential information between the first actual observation data respectively corresponding to the satellite Pi and the satellite Pj, that is, the second satellite differential information herein includes the actual single-difference pseudo-range observation equation and the actual single-difference carrier phase observation equation. Differential processing is performed on the actual pseudo-range observation value and the actual carrier phase observation value, which helps weaken the system positioning error at the initial estimated location of the terminal, and improves location positioning accuracy of the terminal.

S207. Adjust the initial estimated location of the terminal based on the first satellite differential information and the second satellite differential information, to obtain the target location of the terminal.

In this application, the computer device may adjust the initial estimated location of the terminal based on the first satellite differential information and the second satellite differential information, to obtain the target location of the terminal. The target location may be a high-precision location of the terminal. For example, the target location may be accurate to a centimeter level or a decimeter level, to be specific, the target location may be used as the actual location of the terminal, to improve accuracy of location positioning of the terminal, and implement high-precision positioning.

In some embodiments, the adjusting the initial estimated location of the terminal based on the first satellite differential information and the second satellite differential information, to obtain the target location of the terminal includes: performing differential processing on the first satellite differential information and the second satellite differential information to obtain third satellite differential information; determining a location offset based on the third satellite differential information; and adjusting the initial estimated location of the terminal by using the location offset, to obtain the target location of the terminal.

Specifically, the computer device may perform differential processing on the first satellite differential information and the second satellite differential information to obtain third satellite differential information, that is, the third satellite differential information is a double-difference observation equation. The computer device solves the double-difference observation equation to obtain a location offset corresponding to the terminal, and adjusts the initial estimated location of the terminal by using the location offset, to obtain the target location of the terminal. Multiple times of differential processing are performed on the first actual observation data and the virtual observation data, which helps weaken the system positioning error at the initial estimated location of the terminal, improves location positioning accuracy of the terminal, and implements high-precision positioning.

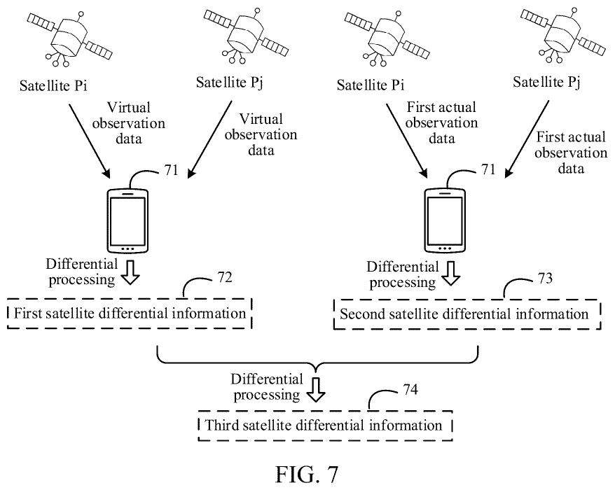

For example, as shown in FIG. 7, a terminal 71 may be any terminal in the terminal cluster 13 in FIG. 1, the satellite Pi and the satellite Pj may be any satellites in the satellite cluster 10 in FIG. 1, and the satellite Pi and the satellite Pj are different. The computer device may perform differential processing on virtual observation data between the satellite Pi and the terminal 71 and virtual observation data between the satellite Pj and the terminal 71, to obtain first satellite differential information 72. The computer device may perform differential processing on first actual observation data between the satellite Pi and the terminal 71 and first actual observation data between the satellite Pj and the terminal 71, to obtain second satellite differential information 73. Further, differential processing is performed on the first satellite differential information 72 and the second satellite differential information 73 to obtain third satellite differential information 74. Multiple times of differential processing are performed on the virtual observation data and the first actual observation data, which helps weaken the system positioning error at the initial estimated location of the terminal, improves location positioning accuracy of the terminal, and implements high-precision positioning.

In some embodiments, the computer device may obtain the third satellite differential information in any one or a combination of the following three manners:

Manner 1: When the first satellite differential information includes a virtual single-difference pseudo-range observation equation, and the second satellite differential information includes an actual single-difference pseudo-range observation equation, difference calculation processing is performed on the virtual single-difference pseudo-range observation equation and the actual single-difference pseudo-range observation equation to obtain a double-difference pseudo-range observation equation, and the double-difference pseudo-range observation equation is used as the third satellite differential information. In this case, the computer device may form a double-difference observation equation set according to the double-difference pseudo-range observation equations respectively corresponding to the N satellites, and solve the double-difference observation equation set to obtain the location offset corresponding to the terminal.

For example, the double-difference pseudo-range observation equations corresponding to the satellite Pi and the satellite Pj may be expressed by using the following formula (5):

∇Δρ=∇ΔR+∇Δdₜᵣₒₚ+∇Δdᵢₒₙ+∇Δd_{orb}∇Δm₁+∇Δε₁ (5)

In formula (5), ∇Δ(*)=Δ(*)ᵢ−Δ(*)ⱼ indicates double-difference operation, for example, ∇Δρ indicates a difference between Δρ1 and Δρ1 indicates a difference between the virtual pseudo-range observation value corresponding to the satellite Pi and the virtual pseudo-range observation value corresponding to the satellite Pj, and Opt indicates a difference between the actual pseudo-range observation value corresponding to the satellite Pi and the actual pseudo-range observation value corresponding to the satellite Pj. It can be learned by comparing formula (5) with formula (3) that a term including the satellite clock difference of the satellite is eliminated, and other related errors such as an ionospheric error and a tropospheric refraction error are further weakened.

Manner 2: When the first satellite differential information includes a virtual single-difference carrier phase observation equation, and the second satellite differential information includes an actual single-difference carrier phase observation equation, difference calculation processing is performed on the virtual single-difference carrier phase observation equation and the actual single-difference carrier phase observation equation to obtain a double-difference carrier phase observation equation, and the double-difference carrier phase observation equation is used as the third satellite differential information. In this case, the computer device may form a double-difference observation equation set according to the double-difference carrier phase observation equations respectively corresponding to the N satellites, and solve the double-difference observation equation set to obtain the location offset corresponding to the terminal.

For example, the double-difference carrier phase observation equations corresponding to the satellite Pi and the satellite Pj may be expressed by using the following formula (6):

∇Δφ=∇ΔR+∇ΔN+∇Δdₜᵣₒₚ−∇Δdᵢₒₙ+∇Δd_{orb}+∇Δm₂+∇Δε₂ (6)

In formula (6), ∇Δ(*)=Δ(*)ᵢ−Δ(*)ⱼ indicates double-difference operation, for example, ∇Δφ indicates a difference between Δφ1 and Δφ2, Δφ1 indicates a difference between the virtual carrier phase observation value corresponding to the satellite Pi and the virtual carrier phase observation value corresponding to the satellite Pj, and Δφ2 indicates a difference between the actual carrier phase observation value corresponding to the satellite Pi and the actual carrier phase observation value corresponding to the satellite Pj. It can be learned by comparing formula (6) with formula (4) that a term including the satellite clock difference of the satellite is eliminated, and other related errors such as an ionospheric error and a tropospheric refraction error are further weakened.

Manner 3: When the first satellite differential information includes a virtual single-difference pseudo-range observation equation and a virtual single-difference carrier phase observation equation, and the second satellite differential information includes an actual single-difference pseudo-range observation equation and an actual single-difference carrier phase observation equation, The computer device may perform difference calculation processing on the virtual single-difference pseudo-range observation equation and the actual single-difference pseudo-range observation equation to obtain double-difference pseudo-range observation equation; perform difference calculation processing on the virtual single-difference carrier phase observation equation and the actual single-difference carrier phase observation equation, to obtain a double-difference carrier phase observation equation; and determine the third satellite differential information according to the double-difference pseudo-range observation equation and the double-difference carrier phase observation equation. In this case, the computer device may form a double-difference observation equation set according to double-difference carrier phase observation equations and double-difference pseudo-range observation equations that are respectively corresponding to the N satellites, and solve the double-difference observation equation set to obtain the location offset corresponding to the terminal.

In this application, the first actual observation data, the second actual observation data, the actual location of the target base station, and the actual locations of the N satellites are obtained, and the initial estimated location of the terminal is determined based on the first actual observation data and the actual locations of the N satellites. The initial estimated location of the terminal is a location for which a system positioning error is not considered. In other words, accuracy of the initial estimated location of the terminal is relatively low. Therefore, the computer device may determine the virtual observation data between the terminal and each satellite based on the first system positioning error and the initial estimated location of the terminal, and perform differential processing on virtual observation data corresponding to every two satellites, to obtain first satellite differential information between the virtual observation data corresponding to every two satellites. Further, differential processing is performed on first actual observation data corresponding to every two satellites, to obtain second satellite differential information between the first actual observation data corresponding to every two satellites, and the initial estimated location of the terminal is adjusted according to the first satellite differential information and the second satellite differential information, to obtain the target location of the terminal. That is, differential processing is performed on the virtual observation data and the first actual observation data, which helps weaken the system positioning error at the initial estimated location of the terminal. In this way, accuracy of location positioning of the terminal can be improved, and high-precision positioning can be implemented.

After the computer device obtains the target location of the terminal, the target location of the terminal may be used in scenarios such as determining a road condition status, route planning, road design, traffic light setting, danger warning, accident judgment, vehicle detection, and location service.

For example, the target location of the terminal is three-dimensional coordinates of the terminal in a world coordinate system. The computer device may perform coordinate transformation on the three-dimensional coordinates of the terminal in the world coordinate system according to a mapping relationship between the world coordinate system and a map coordinate system, to obtain two-dimensional coordinates of the terminal in the map coordinate system, and send the two-dimensional coordinates of the terminal in the map coordinate system to the terminal. The terminal marks the two-dimensional coordinates on an electronic map, so that a user can view a real-time high-precision location of the terminal.

For another example, the computer device may determine, according to the target location of the terminal, road condition information of a target road on which the terminal is located, where the road condition information of the target road includes a smooth state, a congested state, and the like. Further, a status change time of a signal light on the target road side is determined according to the road condition information of the target road, and the status of the signal light on the target road side is changed based on the status change time, which helps relieve a congested state of the target road. For example, the computer device detects that severe congestion occurs in the east to west direction, but there are few vehicles in the south to north direction. Through further analysis, this is because of congestion at a west intersection. In this case, the following measures may be taken: On the one hand, a green light time in the east to west direction is prolonged; and on the other hand, the signal light in the direction from the east intersection to the west intersection is adjusted to the green light until congestion disappears or all directions are balanced.

For another example, the computer device may determine, according to the target location of the terminal, a neighboring terminal that has a neighboring relationship with the terminal; and obtain first vehicle attribute information of a vehicle corresponding to the terminal and second vehicle attribute information of a vehicle corresponding to a neighboring terminal. The vehicle attribute information herein includes a vehicle type, a size of a vehicle, and the like, and the vehicle type includes an ambulance, a police vehicle, a bus, and the like. Further, a first identifier of the vehicle corresponding to the terminal is determined according to the first vehicle attribute information, and a second identifier of the vehicle corresponding to the neighboring terminal is determined according to the second vehicle attribute information. The identifier is used for marking different types of vehicles, and identifiers corresponding to vehicles of different vehicle types have different colors or shapes. For example, a blue identifier is used for representing an ordinary vehicle, and a red identifier is used for representing a special vehicle such as an ambulance or a police car. Alternatively, a round identifier is used for representing a small vehicle, and a rectangle is used for representing a large vehicle. Then, the first identifier may be added to the electronic map according to the target location of the terminal, and the second identifier may be added, according to the location of the neighboring terminal, to the electronic map that includes the first identifier, so as to obtain an updated electronic map. In this way, when the vehicle encounters an emergency, the vehicle allows in time a special vehicle to pass preferably, thereby improving passing flexibility and convenience.

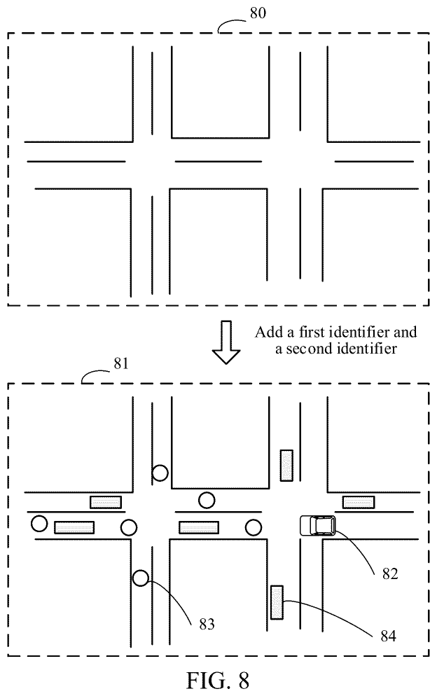

For example, as shown in FIG. 8, it is assumed that a vehicle corresponding to the terminal is a small vehicle, a neighboring terminal that has a neighboring relationship with the terminal may be a terminal whose distance from the terminal is less than a distance threshold, the distance threshold may be 10 m, 20 m, or the like, and vehicles corresponding to the neighboring terminal include a small vehicle and a large vehicle. It is assumed that an electronic map of a region in which the terminal is located is an electronic map 80 in FIG. 8, and the electronic map 80 includes two crossroad-type roads. The computer device may use a vehicle identifier 82 (namely, the first identifier) to represent the vehicle corresponding to the terminal, use a rectangular identifier 84 to represent the large vehicle corresponding to the neighboring terminal, and use a circular identifier 83 to represent the small vehicle corresponding to the neighboring terminal.

In some embodiments, when the user corresponding to the terminal performs zooming processing on the updated electronic map, the computer device may respond to a zooming processing request for updating the electronic map, obtain the updated electronic map obtained after the zooming processing, and separately perform zooming processing on the first identifier and the second identifier according to the updated electronic map obtained after the zooming processing. For example, after zoom-out processing is performed on the updated electronic map, the updated electronic map on which zoom-out processing is performed may be obtained, and zoom-out processing is performed on the first identifier and the second identifier according to the size of the updated electronic map on which zoom-out processing is performed.

Further, because the computer device can obtain a high-precision location of the terminal and a high-precision location of the neighboring terminal, the computer device may remind and warn the vehicle corresponding to the terminal of a potential risk. For example, a traffic accident occurs in an inner lane in the east to west direction. The computer device may send a warning to a vehicle passing in the east to west direction herein in advance, and may further remind and penalize a vehicle that illegally occupies a bus lane and an emergency lane, and when a traffic accident occurs, a driving track of the vehicle related to the accident may be invoked, to perform accident identification and settlement of insurance claim. Alternatively, the computer device may further assist in searching for a stolen or lost vehicle, to help ensure vehicle driving safety.

In some embodiments, to improve confidentiality of the target location corresponding to the terminal, the computer device may encrypt the target location of the terminal and user information corresponding to the terminal, to obtain encrypted data, and may store the encrypted data in a blockchain. The encrypted data can be queried in the blockchain only in a special case. If a traffic accident occurs, a traffic management department may invoke a track of the vehicle related to the accident, to perform responsibility identification and claim adjustment. An electronic map of a terminal corresponding to an ordinary user can display only a location of the ordinary user and a location and a speed of another user around the location of the ordinary user in real time, but does not know specific personal information of a specific user. On a high-precision map, one point is used for representing a vehicle corresponding to one user, and a moving speed of the point is used for representing a speed of the vehicle. In this way, not only a current traffic status is easily understood, but also personal privacy leakage is avoided. With permission of a user, a driving track query and download service that is limited to the user may also be provided.

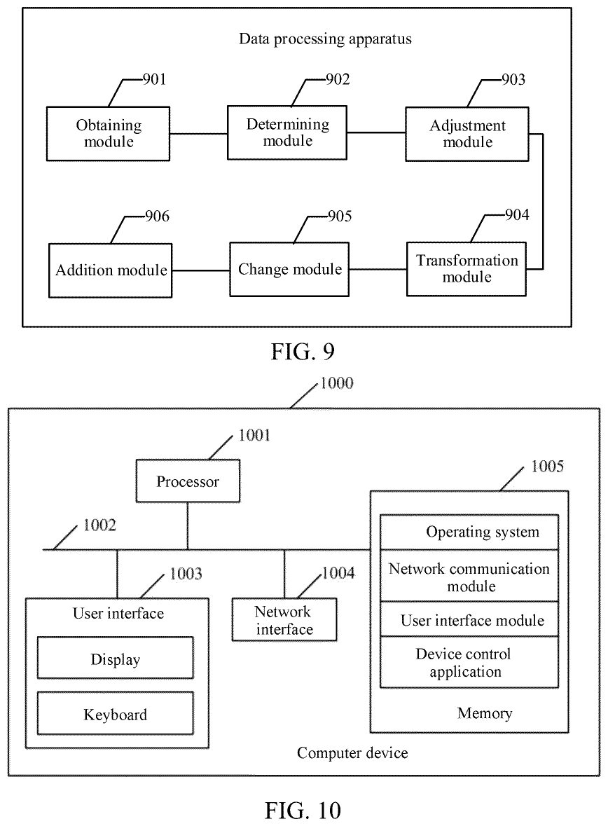

FIG. 9 is a schematic structural diagram of a positioning apparatus according to an embodiment of this application. The positioning apparatus may be a computer program (including program code) running in a computer device. For example, the positioning apparatus is application software. The apparatus may be configured to perform corresponding steps in the method provided in the embodiment of this application. As shown in FIG. 9, the positioning apparatus may include: an obtaining module 901, a determining module 902, an adjustment module 903, a transformation module 904, a change module 905, and an addition module 906.

The obtaining module is configured to obtain first actual observation data, second actual observation data, an actual location of a target base station, and actual locations of N satellites; the first actual observation data being obtained by a terminal by separately performing satellite communication with the N satellites, and the second actual observation data being obtained by the target base station by separately performing satellite communication with the N satellites; the terminal being associated with the target base station; and N being an integer greater than 1;
the determining module is configured to determine an initial estimated location of the terminal based on the first actual observation data and the actual locations of the N satellites; and determine, based on the second actual observation data, the actual location of the target base station, and the actual locations of the N satellites, a first system positioning error corresponding to the initial estimated location of the terminal; and
the adjustment module is configured to adjust the initial estimated location of the terminal according to the first system positioning error and the first actual observation data, to obtain a target location of the terminal.

In some embodiments, that the determining module determines, based on the second actual observation data, the actual location of the target base station, and the actual locations of the N satellites, a first system positioning error corresponding to the initial estimated location of the terminal includes:
determining, based on the second actual observation data, the actual location of the target base station, and the actual locations of the N satellites, a second system positioning error corresponding to the target base station; and
performing interpolation processing on the second system positioning error based on the initial estimated location of the terminal, the actual location of the target base station, and the actual locations of the N satellites, to obtain the first system positioning error corresponding to the initial estimated location of the terminal.

In some embodiments, the second actual observation data includes second actual observation data Qi between the target base station and a satellite Pi, the satellite Pi belongs to the N satellites, and i is a positive integer less than or equal to N; and
that the determining module determines, based on the second actual observation data, the actual location of the target base station, and the actual locations of the N satellites, a second system positioning error corresponding to the target base station includes:
determining an actual distance value between the target base station and the satellite Pi based on the actual location of the target base station and an actual location of the satellite Pi;
determining a difference between the second actual observation data Qi and the actual distance value as a first candidate system positioning error between the target base station and the satellite Pi; and
determining, based on a first candidate system positioning error between the target base station and each of the N satellites, the second system positioning error corresponding to the target base station.

In some embodiments, that the determining module performs interpolation processing on the second system positioning error based on the initial estimated location of the terminal, the actual location of the target base station, and the actual locations of the N satellites, to obtain the first system positioning error corresponding to the initial estimated location of the terminal includes:
obtaining a correlation function between the actual location of the target base station, the actual locations of the N satellites, and the second system positioning error;
determining a second candidate system positioning error between the terminal and the satellite Pi based on the correlation function, the initial estimated location of the terminal, and the actual location of the satellite Pi; and
determining, based on a second candidate system positioning error between the terminal and each of the N satellites, the first system positioning error corresponding to the initial estimated location of the terminal.

In some embodiments, that the adjustment module adjusts the initial estimated location of the terminal according to the first system positioning error and the first actual observation data, to obtain a target location of the terminal includes:
determining virtual observation data between the terminal and each satellite based on the first system positioning error and the initial estimated location of the terminal;
performing differential processing on virtual observation data corresponding to every two satellites, to obtain first satellite differential information between the virtual observation data corresponding to every two satellites;
performing differential processing on first actual observation data corresponding to every two satellites, to obtain second satellite differential information between the first actual observation data corresponding to every two satellites; and
adjusting the initial estimated location of the terminal based on the first satellite differential information and the second satellite differential information, to obtain the target location of the terminal.

In some embodiments, virtual observation data between the terminal and a satellite Pi includes a first virtual pseudo-range observation value and a first virtual carrier phase observation value, and virtual observation data between the terminal and a satellite Pj includes a second virtual pseudo-range observation value and a second virtual carrier phase observation value; both the satellite Pi and the satellite Pj belong to the N satellites, and both i and j are positive integers less than or equal to N; j is different from i; and
that the adjustment module performs differential processing on virtual observation data corresponding to every two satellites, to obtain first satellite differential information between the virtual observation data corresponding to every two satellites includes:
determining a first virtual pseudo-range observation equation corresponding to the first virtual pseudo-range observation value, and determining a second virtual pseudo-range observation equation corresponding to the second virtual pseudo-range observation value;
determining a first virtual carrier phase observation equation corresponding to the first virtual carrier phase observation value, and determining a second virtual carrier phase observation equation corresponding to the second virtual carrier phase observation value; and
determining, according to the first virtual pseudo-range observation equation, the second virtual pseudo-range observation equation, the first virtual carrier phase observation equation, and the second virtual carrier phase observation equation, first satellite differential information between virtual observation data respectively corresponding to the satellite Pi and the satellite Pj.

In some embodiments, that the adjustment module determines, according to the first virtual pseudo-range observation equation, the second virtual pseudo-range observation equation, the first virtual carrier phase observation equation, and the second virtual carrier phase observation equation, first satellite differential information between virtual observation data respectively corresponding to the satellite Pi and the satellite Pj includes:
performing difference calculation processing on the first virtual pseudo-range observation equation and the second virtual pseudo-range observation equation to obtain a virtual single-difference pseudo-range observation equation;
performing difference calculation processing on the first virtual carrier phase observation equation and the second virtual carrier phase observation equation to obtain a virtual single-difference carrier phase observation equation; and
determining, according to the virtual single-difference pseudo-range observation equation and the virtual single-difference carrier phase observation equation, the first satellite differential information between the virtual observation data respectively corresponding to the satellite Pi and the satellite Pj.

In some embodiments, first actual observation data between the terminal and a satellite Pi includes a first actual pseudo-range observation value and a first actual carrier phase observation value, and first actual observation data between the terminal and a satellite Pj includes a second actual pseudo-range observation value and a second actual carrier phase observation value; and that the adjustment module performs differential processing on first actual observation data corresponding to every two satellites, to obtain second satellite differential information between the first actual observation data corresponding to every two satellites includes:
determining a first actual pseudo-range observation equation corresponding to the first actual pseudo-range observation value, and determining a second actual pseudo-range observation equation corresponding to the second actual pseudo-range observation value;
determining a first actual carrier phase observation equation corresponding to the first actual carrier phase observation value, and determining a second actual carrier phase observation equation corresponding to the second actual carrier phase observation value; and
determining, according to the first actual pseudo-range observation equation, the second actual pseudo-range observation equation, the first actual carrier phase observation equation, and the second actual carrier phase observation equation, second satellite differential information between first actual observation data respectively corresponding to the satellite Pi and the satellite Pj.

In some embodiments, that the adjustment module determines, according to the first actual pseudo-range observation equation, the second actual pseudo-range observation equation, the first actual carrier phase observation equation, and the second actual carrier phase observation equation, second satellite differential information between first actual observation data respectively corresponding to the satellite Pi and the satellite Pj includes:
performing difference calculation processing on the first actual pseudo-range observation equation and the second actual pseudo-range observation equation to obtain an actual single-difference pseudo-range observation equation;
performing difference calculation processing on the first actual carrier phase observation equation and the second actual carrier phase observation equation to obtain an actual single-difference carrier phase observation equation; and
determining, according to the actual single-difference pseudo-range observation equation and the actual single-difference carrier phase observation equation, the second satellite differential information between the first actual observation data respectively corresponding to the satellite Pi and the satellite Pj.

In some embodiments, that the adjustment module adjusts the initial estimated location of the terminal based on the first satellite differential information and the second satellite differential information, to obtain the target location of the terminal includes:
performing differential processing on the first satellite differential information and the second satellite differential information to obtain third satellite differential information;
determining a location offset based on the third satellite differential information; and
adjusting the initial estimated location of the terminal by using the location offset, to obtain the target location of the terminal.

In some embodiments, that the adjustment module performs differential processing on the first satellite differential information and the second satellite differential information to obtain third satellite differential information includes:
performing difference calculation processing on a virtual single-difference pseudo-range observation equation included in the first satellite differential information and an actual single-difference pseudo-range observation equation included in the second satellite differential information, to obtain a double-difference pseudo-range observation equation;
performing difference calculation processing on a virtual single-difference carrier phase observation equation included in the first satellite differential information and an actual single-difference carrier phase observation equation included in the second satellite differential information, to obtain a double-difference carrier phase observation equation; and
determining the third satellite differential information according to the double-difference pseudo-range observation equation and the double-difference carrier phase observation equation.

In some embodiments, the target location of the terminal is three-dimensional coordinates of the terminal in a world coordinate system; and the transformation module is configured to perform coordinate transformation on three-dimensional coordinates of the terminal in a world coordinate system, to obtain two-dimensional coordinates of the terminal in a map coordinate system; and send the two-dimensional coordinates of the terminal in the map coordinate system to the terminal, so that the terminal marks the two-dimensional coordinates in an electronic map.

In some embodiments, the change module is configured to determine, according to the target location of the terminal, road condition information of a target road on which the terminal is located; determine a status change time of a signal light on the target road side according to the road condition information of the target road; and change the status of the signal light on the target road side based on the status change time.

In some embodiments, the addition module is configured to determine, according to the target location of the terminal, a neighboring terminal that has a neighboring relationship with the terminal; obtain first vehicle attribute information of a vehicle corresponding to the terminal and second vehicle attribute information of a vehicle corresponding to a neighboring terminal; determine, according to the first vehicle attribute information, a first identifier of a vehicle corresponding to the terminal, and determine, according to the second vehicle attribute information, a second identifier of a vehicle corresponding to the neighboring terminal; and add the first identifier to the electronic map according to the target location of the terminal, and add the second identifier to an electronic map including the first identifier according to a location of the neighboring terminal, to obtain an updated electronic map.

In some embodiments, the addition module is configured to: respond to a zooming processing request for the updated the electronic map, and obtain an updated electronic map obtained after zooming processing; and separately perform zooming processing on the first identifier and the second identifier according to the updated electronic map obtained after zooming processing.

According to an embodiment of this application, the steps in the positioning method shown in FIG. 3 may be performed by the modules in the positioning apparatus shown in FIG. 9. For example, step S101 shown in FIG. 3 may be performed by the obtaining module 901 in FIG. 9, and step S102 and step S103 shown in FIG. 3 may be performed by the determining module 902 in FIG. 9. Step S104 shown in FIG. 3 may be performed by the adjustment module 903 in FIG. 9.

According to an embodiment of this application, the modules in the positioning apparatus shown in FIG. 9 may be separately or completely combined into one or more units, or one (some) of the units may be further divided into at least two functionally smaller subunits, so that the same operation can be implemented without affecting implementation of a technical effect of this embodiment of this application. The foregoing modules are divided based on logical functions. In actual application, a function of one module may be implemented by at least two units, or a function of at least two modules is implemented by one unit. In another embodiment of this application, the positioning apparatus may alternatively include other units. In actual application, these functions may be implemented with the assistance of other units, and may be cooperatively implemented by at least two units.

According to an embodiment of this application, the data processing apparatus shown in FIG. 9 may be constructed by running a computer program (including program code) capable of performing steps related to the corresponding methods shown in FIG. 3 and FIG. 6 on a general-purpose computer device including a processing element such as a central processing unit (CPU), a random access storage medium (RAM), a read-only storage medium (ROM), and a storage element, for example, a computer, to implement the data processing method in the embodiment of this application. The computer program may be recorded in, for example, a non-transitory computer-readable recording medium, and may be loaded into the foregoing computing device by using the computer readable recording medium, and run in the computing device.

In this application, the first actual observation data, the second actual observation data, the actual location of the target base station, and the actual locations of the N satellites are obtained, and the initial estimated location of the terminal is determined based on the first actual observation data and the actual locations of the N satellites. The initial estimated location of the terminal is a location for which a system positioning error is not considered. In other words, accuracy of the initial estimated location of the terminal is relatively low. Therefore, the computer device may determine, based on the second actual observation data, the actual locations of the N satellites, and the actual location of the target base station, the first system positioning error corresponding to the initial estimated location of the terminal. The first system positioning error is used for reflecting the accuracy of the initial estimated location of the terminal. Further, the initial estimated location of the terminal may be adjusted according to the first system positioning error and the first actual observation data, to obtain the target location of the terminal. In this way, location positioning accuracy of the terminal can be improved, and high-precision positioning can be implemented.

Referring to FIG. 10, FIG. 10 is a schematic structural diagram of a computer device according to an embodiment of this application. As shown in FIG. 10, a computer device 1000 may include: a processor 1001, a network interface 1004, and a memory 1005. In addition, the foregoing computer device 1000 may further include: a user interface 1003 and at least one communication bus 1002. The communication bus 1002 is configured to implement connection and communication between these components. The user interface 1003 may include a display and a keyboard. In some embodiments, the user interface 1003 may further include a standard wired interface and wireless interface. The network interface 1004 may include a standard wired interface and wireless interface (for example, a Wi-Fi interface). The memory 1005 may be a high-speed random access memory (RAM), or may be a non-volatile memory, for example, at least one magnetic disk storage. In some embodiments, the memory 1005 may include at least one storage apparatus that is remotely disposed relative to the processor 1001. As shown in FIG. 10, the memory 1005 used as a non-transitory computer-readable storage medium may include an operating system, a network communication module, a user interface module, and a device-control application program.

In the computer device 1000 shown in FIG. 10, the network interface 1004 may provide a network communication function. The user interface 1003 is mainly configured to provide an input interface. The processor 1001 may be configured to invoke a device-control application program stored in the memory 1005, to implement the positioning method provided in the embodiments of this application.

It is to be understood that the computer device 1000 described in this embodiment of this application may perform descriptions of the positioning method in FIG. 3 and the embodiment corresponding to FIG. 6, or may perform descriptions of the positioning apparatus in the embodiment corresponding to FIG. 9. Details are not described herein again. In addition, the description of beneficial effects of the same method are not described herein again.

In addition, an embodiment of this application further provides a non-transitory computer-readable storage medium. The computer readable storage medium stores a computer program executed by the positioning apparatus mentioned above, and the computer program includes program instructions. When executing the program instructions, the processor can perform the descriptions of the positioning method in the embodiments corresponding to FIG. 3 and FIG. 6. Therefore, details are not described herein again. In addition, the description of beneficial effects of the same method are not described herein again. For technical details that are not disclosed in the computer readable storage medium embodiments of this application, refer to the descriptions of the method embodiments of this application.

For example, the program instructions may be deployed on one computer device for execution, or may be deployed on at least two computer devices at one location for execution, or may be executed on at least two computer devices distributed in at least two locations and interconnected by using a communication network. The at least two computer devices distributed in the at least two locations and interconnected by using the communication network may form a blockchain network.

The computer readable storage medium may be an internal storage unit of the positioning apparatus or the computer device provided in any one of the foregoing embodiments, for example, a hard disk or an internal memory of the computer device. The computer readable storage medium may also be an external storage device of the computer device, for example, a plug type hard disk, a smart media card (SMC), a secure digital (SD) card, and a flash card that are configured on the computer device. Further, the computer readable storage medium may further include an internal storage unit of the computer device and an external storage device. The computer readable storage medium is configured to store the computer program and other programs and data required by the computer device. The computer readable storage medium may be further configured to temporarily store data that has been or is to be output.

The terms “first” and “second” in the specification, claims, and accompanying drawings of the embodiments of this application are used for distinguishing between different media content, and are not used for describing a specific sequence. In addition, the term “include” and any variant thereof are intended to cover a non-exclusive inclusion. For example, a process, method, apparatus, product, or device that includes a series of steps or units is not limited to the listed steps or modules; and instead, further includes a step or module that is not listed, or further includes another step or unit that is intrinsic to the process, method, apparatus, product, or device.

An embodiment of this application further provides a computer program product, including a computer program/instructions. When the computer program/instructions are executed by a processor, the foregoing positioning method described in the embodiments corresponding to FIG. 3 and FIG. 6 is implemented. Therefore, details are not described herein again. In addition, the description of beneficial effects of the same method are not described herein again. For technical details related to the computer program product embodiment in this application, refer to the description in the method embodiment of this application.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are executed in a mode of hardware or software depends on particular applications and design constraint conditions of the technical solutions. Those skilled in the art may use different methods to implement the described functions for each particular application, but such implementation is not to be considered beyond the scope of this application.

The method and the related apparatus provided in the embodiments of this application are described with reference to a flowchart and/or a schematic structural diagram of the method provided in the embodiments of this application. Specifically, each process and/or block of the method flowchart and/or the schematic structural diagram of the method may be implemented by a computer program instruction, and a combination of the process and/or block in the flowchart and/or block diagram. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the schematic structural diagram. These computer program instructions may also be stored in a non-transitory computer-readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the schematic structural diagram. These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagram.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A method for positioning a terminal performed by a computer device, the method comprising:
determining an initial estimated location of the terminal based on the first actual observation data obtained by a terminal by separately performing satellite communication with multiple satellites and actual locations of the satellites;
determining a first system positioning error corresponding to the initial estimated location of the terminal based on an actual location of a target base station associated with the terminal, second actual observation data obtained by the target base station by separately performing satellite communication with the satellites, and the actual locations of the satellites; and
adjusting the initial estimated location of the terminal according to the first system positioning error and the first actual observation data, to obtain a target location of the terminal.

2. The method according to claim 1, wherein the determining a first system positioning error corresponding to the initial estimated location of the terminal comprises:
determining a second system positioning error corresponding to the target base station based on the second actual observation data, the actual location of the target base station, and the actual locations of the satellites; and
performing interpolation processing on the second system positioning error based on the initial estimated location of the terminal, the actual location of the target base station, and the actual locations of the satellites, to obtain the first system positioning error corresponding to the initial estimated location of the terminal.

3. The method according to claim 2, wherein the second actual observation data comprises second actual observation data Qi between the target base station and a satellite Pi; and
the determining a second system positioning error corresponding to the target base station based on the second actual observation data, the actual location of the target base station, and the actual locations of the satellites comprises:
determining an actual distance value between the target base station and the satellite Pi;
determining a difference between the second actual observation data Qi and the actual distance value as a first candidate system positioning error between the target base station and the satellite Pi; and
determining the second system positioning error corresponding to the target base station based on a first candidate system positioning error between the target base station and each of the satellites.

4. The method according to claim 1, wherein the adjusting the initial estimated location of the terminal according to the first system positioning error and the first actual observation data, to obtain a target location of the terminal comprises:
determining virtual observation data between the terminal and each satellite based on the first system positioning error and the initial estimated location of the terminal;
performing differential processing on virtual observation data corresponding to every two satellites, to obtain first satellite differential information between the virtual observation data corresponding to every two satellites;
performing differential processing on first actual observation data corresponding to every two satellites, to obtain second satellite differential information between the first actual observation data corresponding to every two satellites; and
adjusting the initial estimated location of the terminal based on the first satellite differential information and the second satellite differential information, to obtain the target location of the terminal.

5. The method according to claim 4, wherein virtual observation data between the terminal and a satellite Pi comprises a first virtual pseudo-range observation value and a first virtual carrier phase observation value, and virtual observation data between the terminal and a satellite Pj comprises a second virtual pseudo-range observation value and a second virtual carrier phase observation value; both the satellite Pi and the satellite Pj belong to the satellites, j is different from i.

6. The method according to claim 4, wherein first actual observation data between the terminal and a satellite Pi comprises a first actual pseudo-range observation value and a first actual carrier phase observation value, and first actual observation data between the terminal and a satellite Pj comprises a second actual pseudo-range observation value and a second actual carrier phase observation value.

7. The method according to claim 4, wherein the adjusting the initial estimated location of the terminal based on the first satellite differential information and the second satellite differential information, to obtain the target location of the terminal comprises:
performing differential processing on the first satellite differential information and the second satellite differential information to obtain third satellite differential information;
determining a location offset based on the third satellite differential information; and
adjusting the initial estimated location of the terminal by using the location offset, to obtain the target location of the terminal.

8. A computer device, comprising: a processor and a memory,
the processor being connected to the memory; and the memory being configured to store program code that, when executed by the processor, causing the computer device to perform a method for positioning a terminal, the method comprising:
determining an initial estimated location of the terminal based on the first actual observation data obtained by a terminal by separately performing satellite communication with multiple satellites and actual locations of the satellites;
determining a first system positioning error corresponding to the initial estimated location of the terminal based on an actual location of a target base station associated with the terminal, second actual observation data obtained by the target base station by separately performing satellite communication with the satellites, and the actual locations of the satellites; and
adjusting the initial estimated location of the terminal according to the first system positioning error and the first actual observation data, to obtain a target location of the terminal.

9. The computer device according to claim 8, wherein the determining a first system positioning error corresponding to the initial estimated location of the terminal comprises:
determining a second system positioning error corresponding to the target base station based on the second actual observation data, the actual location of the target base station, and the actual locations of the satellites; and
performing interpolation processing on the second system positioning error based on the initial estimated location of the terminal, the actual location of the target base station, and the actual locations of the satellites, to obtain the first system positioning error corresponding to the initial estimated location of the terminal.

10. The computer device according to claim 9, wherein the second actual observation data comprises second actual observation data Qi between the target base station and a satellite Pi; and
the determining a second system positioning error corresponding to the target base station based on the second actual observation data, the actual location of the target base station, and the actual locations of the satellites comprises:
determining an actual distance value between the target base station and the satellite Pi;
determining a difference between the second actual observation data Qi and the actual distance value as a first candidate system positioning error between the target base station and the satellite Pi; and
determining the second system positioning error corresponding to the target base station based on a first candidate system positioning error between the target base station and each of the satellites.

11. The computer device according to claim 8, wherein the adjusting the initial estimated location of the terminal according to the first system positioning error and the first actual observation data, to obtain a target location of the terminal comprises:
determining virtual observation data between the terminal and each satellite based on the first system positioning error and the initial estimated location of the terminal;
performing differential processing on virtual observation data corresponding to every two satellites, to obtain first satellite differential information between the virtual observation data corresponding to every two satellites;
performing differential processing on first actual observation data corresponding to every two satellites, to obtain second satellite differential information between the first actual observation data corresponding to every two satellites; and
adjusting the initial estimated location of the terminal based on the first satellite differential information and the second satellite differential information, to obtain the target location of the terminal.

12. The computer device according to claim 11, wherein virtual observation data between the terminal and a satellite Pi comprises a first virtual pseudo-range observation value and a first virtual carrier phase observation value, and virtual observation data between the terminal and a satellite Pj comprises a second virtual pseudo-range observation value and a second virtual carrier phase observation value.

13. The computer device according to claim 11, wherein first actual observation data between the terminal and a satellite Pi comprises a first actual pseudo-range observation value and a first actual carrier phase observation value, and first actual observation data between the terminal and a satellite Pj comprises a second actual pseudo-range observation value and a second actual carrier phase observation value.

14. The computer device according to claim 11, wherein the adjusting the initial estimated location of the terminal based on the first satellite differential information and the second satellite differential information, to obtain the target location of the terminal comprises:
performing differential processing on the first satellite differential information and the second satellite differential information to obtain third satellite differential information;
determining a location offset based on the third satellite differential information; and
adjusting the initial estimated location of the terminal by using the location offset, to obtain the target location of the terminal.

15. A non-transitory computer readable storage medium, storing program instructions that, when executed by a processor of a computer device, cause the computer device to perform a method for positioning a terminal, the method comprising:
determining an initial estimated location of the terminal based on the first actual observation data obtained by a terminal by separately performing satellite communication with multiple satellites and actual locations of the satellites;
determining a first system positioning error corresponding to the initial estimated location of the terminal based on an actual location of a target base station associated with the terminal, second actual observation data obtained by the target base station by separately performing satellite communication with the satellites, and the actual locations of the satellites; and
adjusting the initial estimated location of the terminal according to the first system positioning error and the first actual observation data, to obtain a target location of the terminal.

16. The non-transitory computer readable storage medium according to claim 15, wherein the determining a first system positioning error corresponding to the initial estimated location of the terminal comprises:
determining a second system positioning error corresponding to the target base station based on the second actual observation data, the actual location of the target base station, and the actual locations of the satellites; and
performing interpolation processing on the second system positioning error based on the initial estimated location of the terminal, the actual location of the target base station, and the actual locations of the satellites, to obtain the first system positioning error corresponding to the initial estimated location of the terminal.

17. The non-transitory computer readable storage medium according to claim 15, wherein the adjusting the initial estimated location of the terminal according to the first system positioning error and the first actual observation data, to obtain a target location of the terminal comprises:
determining virtual observation data between the terminal and each satellite based on the first system positioning error and the initial estimated location of the terminal;
performing differential processing on virtual observation data corresponding to every two satellites, to obtain first satellite differential information between the virtual observation data corresponding to every two satellites;
performing differential processing on first actual observation data corresponding to every two satellites, to obtain second satellite differential information between the first actual observation data corresponding to every two satellites; and
adjusting the initial estimated location of the terminal based on the first satellite differential information and the second satellite differential information, to obtain the target location of the terminal.

18. The non-transitory computer readable storage medium according to claim 17, wherein virtual observation data between the terminal and a satellite Pi comprises a first virtual pseudo-range observation value and a first virtual carrier phase observation value, and virtual observation data between the terminal and a satellite Pj comprises a second virtual pseudo-range observation value and a second virtual carrier phase observation value.

19. The non-transitory computer readable storage medium according to claim 17, wherein first actual observation data between the terminal and a satellite Pi comprises a first actual pseudo-range observation value and a first actual carrier phase observation value, and first actual observation data between the terminal and a satellite Pj comprises a second actual pseudo-range observation value and a second actual carrier phase observation value.

20. The non-transitory computer readable storage medium according to claim 17, wherein the adjusting the initial estimated location of the terminal based on the first satellite differential information and the second satellite differential information, to obtain the target location of the terminal comprises:
performing differential processing on the first satellite differential information and the second satellite differential information to obtain third satellite differential information;
determining a location offset based on the third satellite differential information; and
adjusting the initial estimated location of the terminal by using the location offset, to obtain the target location of the terminal.
